(19) United States
(12) Patent Application Publication
(10) Pub. No.: US 2022/0237600 A1
(43) Pub. Date: Jul. 28, 2022

(54) BLOCKCHAIN-BASED RESOURCE TRANSFER METHOD, APPARATUS, NODE DEVICE, AND STORAGE MEDIUM

(71) Applicant: TENCENT TECHNOLOGY (SHENZHEN) COMPANY LIMITED, Shenzhen (CN)

(72) Inventor: Mingyang JIANG, Shenzhen (CN)

(21) Appl. No.: 17/720,853

(22) Filed: Apr. 14, 2022

Related U.S. Application Data
(63) Continuation of application No. PCT/CN2020/133071, filed on Dec. 1, 2020.

(30) Foreign Application Priority Data
Mar. 18, 2020 (CN) 202010192895.9

(51) Int. Cl. G06Q 20/38; G06Q 20/06

(52) U.S. Cl. CPC G06Q 20/389; G06Q 20/0658

(57) ABSTRACT

A method includes: receiving a first service request, the first service request including a first account and a first service, and the first service being corresponding to a first quantity of virtual resources; transferring the first quantity of the virtual resources from the first account to a second account of the node device in response to the virtual resources stored in the first account being not less than the first quantity, and providing the first service to the first account; broadcasting a first target block to the blockchain system, the first target block including a resource transfer record and a service provision record corresponding to the first service request; and adding the first target block to a blockchain of the node device in response to the first target block passing a consensus check.

### RELATED APPLICATION(S)

This application is a continuation application of PCT Patent Application No. PCT/CN2020/133071 filed on Dec. 1, 2020, which claims priority to Chinese Patent Application No. 202010192895.9, entitled “BLOCKCHAIN-BASED RESOURCE TRANSFER METHOD, APPARATUS, NODE DEVICE, AND STORAGE MEDIUM” filed on Mar. 18, 2020, all of which are incorporated herein by reference in entirety.

### FIELD OF THE TECHNOLOGY

The present disclosure relates to the field of blockchain technologies, and in particular, to a blockchain-based resource transfer method, apparatus, node device, and storage medium.

### BACKGROUND

With the development of Internet technologies, various Internet services emerge one after another. Users can pay a certain fee to merchants to purchase corresponding services, which include daily life services and commodities. In order to continue to attract users, merchants reward users with virtual resources such as points, red reward envelopes, and coupons used for deduction to promote users' consumption. However, because different merchants have different deduction rules and virtual resources issued by different merchants are not universal, the virtual resources owned by users cannot be effectively used.

A merchant may maintain its own virtual resource system. Multiple merchants can work together to formulate a virtual resource exchange agreement to negotiate exchange ratios between different virtual resources of different merchants. When a user may exchange virtual resources A of a merchant A for virtual resources B of a merchant B, the user transmits an exchange request to a virtual resource system B of the merchant B. The virtual resource system B of the merchant B calculates a quantity of virtual resources B to be exchanged by virtual resources A according to the exchange ratio in the agreement, and then transmits a virtual resource exchange request to a virtual resource system A of the merchant A according to the quantity of virtual resources B to be exchanged. After receiving the virtual resource exchange request, the virtual resource system A of the merchant A determines validity of the virtual resource exchange request; determines whether the total amount of virtual resources A in an account of the user is sufficient to pay the current exchange; and after determining that the payment can be made, deducts a corresponding quantity of virtual resources A from the account of the user and transfers the corresponding quantity of virtual resources A to an account of the merchant B, and at the same time, generates and transmits an exchange successful instruction to the virtual resource system B. After receiving the virtual resources A and the exchange successful instruction, the virtual resource system B provides the user with a corresponding quantity of virtual resources B. In this way, the virtual resources of different merchants can be circulated within a certain range.

In certain existing technologies, to exchange virtual resources of one merchant for virtual resources of another merchant, the two virtual resource systems of the two merchants perform multiple data interactions, and the efficiency of data transmission and data processing may be low.

### SUMMARY

Embodiments of the present disclosure provide a blockchain-based resource transfer method, apparatus, node device, and storage medium, which can simplify the data processing steps for exchanging virtual resources between different merchants and improve the data processing efficiency. The technical solutions are as follows.

In one aspect, the present disclosure provides a resource transfer method based on a blockchain system, applied to a node device in the blockchain system. The method includes: receiving a first service request, the first service request including a first account and a first service, and the first service being corresponding to a first quantity of virtual resources; transferring the first quantity of the virtual resources from the first account to a second account of the node device in response to a quantity of the virtual resources stored in the first account being not less than the first quantity, and providing the first service to the first account; broadcasting a first target block to the blockchain system, the first target block including a resource transfer record and a service provision record corresponding to the first service request; and adding the first target block to a blockchain of the node device in response to the first target block passing a consensus check, the virtual resource including at least one of an institutional virtual resource or a universal virtual resource, the institutional virtual resource being generated by the node device, the universal virtual resource being generated by a central node device in the blockchain system, and the institutional virtual resource and the universal virtual resource being correspondingly transferred according to a transfer ratio.

In another aspect, the present disclosure provides a resource transfer method based on a blockchain system, applied to a central node device in the blockchain system. The method includes: receiving a second service request, the second service request including a fourth account and a second service, and the second service being corresponding to a third quantity of universal virtual resources; transferring the third quantity of the universal virtual resources from the fourth account to a third account of the central node device in response to a quantity of the universal virtual resources stored in the fourth account being not less than the third quantity, and providing the second service to the fourth account, the universal virtual resource being generated by the central node device, and the universal virtual resources stored in the fourth account being transferred to the fourth account by the central node device; broadcasting a second target block to the blockchain system, the second target block including a resource transfer record and a service provision record corresponding to the second service request; and adding the second target block to a blockchain of the central node device in response to the second target block passing a consensus check.

In yet another aspect, the present disclosure provides a resource transfer apparatus, including a memory storing computer program instructions; and a processor coupled to the memory and configured to execute the computer program instructions and perform: receiving a first service request, the first service request including a first account and a first service, and the first service being corresponding to a first quantity of virtual resources; transferring the first quantity of the virtual resources from the first account to a second account of the node device in response to a quantity of the virtual resources stored in the first account being not less than the first quantity, and provide the first service to the first account; broadcasting a first target block to the blockchain system, the first target block including a resource transfer record and a service provision record corresponding to the first service request; and adding the first target block to a blockchain of the node device in response to the first target block passing a consensus check, the virtual resource including at least one of an institutional virtual resource or a universal virtual resource, the institutional virtual resource being generated by a node device, the universal virtual resource being generated by a central node device in the blockchain system, and the institutional virtual resource and the universal virtual resource being correspondingly transferred according to a transfer ratio.

In yet another aspect, the present disclosure provides a non-transitory computer-readable storage medium storing computer program instructions executable by at least one processor to perform: receiving a first service request, the first service request including a first account and a first service, and the first service being corresponding to a first quantity of virtual resources; transferring the first quantity of the virtual resources from the first account to a second account of the node device in response to the virtual resources stored in the first account being not less than the first quantity, and providing the first service to the first account; broadcasting a first target block to the blockchain system, the first target block including a resource transfer record and a service provision record corresponding to the first service request; and adding the first target block to a blockchain of the node device in response to the first target block passing a consensus check, the virtual resource including at least one of an institutional virtual resource or a universal virtual resource, the institutional virtual resource being generated by a node device, the universal virtual resource being generated by a central node device in a blockchain system, and the institutional virtual resource and the universal virtual resource being correspondingly transferred according to a transfer ratio.

The technical solutions provided in the embodiments of the present disclosure bring about the following beneficial effects:

By using the blockchain system, each merchant has a corresponding node device on the blockchain system. There are two types of virtual resources in the blockchain system: institutional virtual resources and universal virtual resources. The institutional virtual resources are generated by the node devices of the merchants, and the universal virtual resources are generated by a central node of the blockchain system. A user may transfer institutional virtual resources or universal virtual resources to a node device to obtain a service provided by the node device. The user may transfer a certain quantity of institutional virtual resources to the node device according to a transfer ratio to obtain universal virtual resources transferred from the node device to an account of the user. In this way, the user can exchange institutional virtual resources of one merchant for universal virtual resources, and then exchange the universal virtual resources for institutional virtual resources of the node device of another merchant, thereby realizing the exchange of virtual resources of different merchants. Moreover, each time when a virtual resource transfer occurs in the blockchain system, each node will store a record of the virtual resource transfer. Therefore, each node stores the virtual resource storage status of each user account, and a node device can perform a virtual resource transfer without having to exchange data with the node device of any other merchant, which simplifies the data processing steps and data transmission times for transferring virtual resources, improves the efficiency, and reduces the costs of merchants in maintaining their virtual resource systems.

Other aspects of the present disclosure can be understood by those skilled in the art in light of the description, the claims, and the drawings of the present disclosure.

### BRIEF DESCRIPTION OF THE DRAWINGS

To facilitate a better understanding of technical solutions of certain embodiments of the present disclosure, accompanying drawings are described below. The accompanying drawings are illustrative of certain embodiments of the present disclosure, and a person of ordinary skill in the art may still derive other drawings from these accompanying drawings without having to exert creative efforts. When the following descriptions are made with reference to the accompanying drawings, unless otherwise indicated, same numbers in different accompanying drawings may represent same or similar elements. In addition, the accompanying drawings are not necessarily drawn to scale.

FIG. 1 is a schematic system architecture diagram of a blockchain system according to embodiment(s) of the present disclosure;

FIG. 2 is a schematic structural diagram of a blockchain according to embodiment(s) of the present disclosure;

FIG. 3 is a schematic flowchart showing generation of a new block according to embodiment(s) of the present disclosure;

FIG. 4 is a schematic functional architecture diagram of node devices in a blockchain system according to embodiment(s) of the present disclosure;

FIG. 5 is a schematic flowchart of a blockchain-based resource transfer method according to embodiment(s) of the present disclosure;

FIG. 6 is a schematic flowchart of another blockchain-based resource transfer method according to embodiment(s) of the present disclosure;

FIG. 7 is a schematic flowchart showing auditing of a consortium node by a central node according to embodiment(s) of the present disclosure;

FIG. 8 is a schematic diagram showing circulation of universal virtual resources according to embodiment(s) of the present disclosure;

FIG. 9 is a schematic diagram showing circulation of universal virtual resources according to embodiment(s) of the present disclosure;

FIG. 10 is a schematic diagram showing circulation of universal virtual resources according to embodiment(s) of the present disclosure;

FIG. 11 is a schematic diagram showing circulation of universal virtual resources according to embodiment(s) of the present disclosure;

FIG. 12 is a schematic diagram showing circulation of institutional virtual resources according to embodiment(s) of the present disclosure;

FIG. 13 is a schematic diagram showing circulation of institutional virtual resources according to embodiment(s) of the present disclosure;

FIG. 14 is a schematic diagram showing circulation of institutional virtual resources according to embodiment(s) of the present disclosure;

FIG. 15 is a schematic diagram showing circulation of institutional virtual resources according to embodiment(s) of the present disclosure;

FIG. 16 is a schematic diagram of a double-layer virtual resource network according to embodiment(s) of the present disclosure;

FIG. 17 is a schematic block diagram of a resource transfer apparatus based on a blockchain system according to embodiment(s) of the present disclosure;

FIG. 18 is a schematic block diagram of another resource transfer apparatus based on a blockchain system according to embodiment(s) of the present disclosure;

FIG. 19 is a schematic structural block diagram of a terminal according to embodiment(s) of the present disclosure; and

FIG. 20 is a schematic structural diagram of a computing device according to embodiment(s) of the present disclosure.

### DETAILED DESCRIPTION

To make objectives, technical solutions, and/or advantages of the present disclosure more comprehensible, certain embodiments of the present disclosure are further elaborated in detail with reference to the accompanying drawings. The embodiments as described are not to be construed as a limitation to the present disclosure. All other embodiments obtained by a person of ordinary skill in the art without creative efforts shall fall within the protection scope of embodiments of the present disclosure.

When and as applicable, the term “an embodiment,” “one embodiment,” “some embodiment(s), “some embodiments,” “certain embodiment(s),” or “certain embodiments” may refer to one or more subsets of all possible embodiments. When and as applicable, the term “an embodiment,” “one embodiment,” “some embodiment(s), “some embodiments,” “certain embodiment(s),” or “certain embodiments” may refer to the same subset or different subsets of all the possible embodiments, and can be combined with each other without conflict.

In certain embodiments, the term “based on” is employed herein interchangeably with the term “according to.”

Terms involved in embodiment(s) of the present disclosure are explained below.

Blockchain: It is a new application mode of computer technologies such as distributed data storage, point-to-point transmission, a consensus mechanism, and an encryption algorithm. The blockchain is essentially a decentralized database and is a string of data blocks generated through association by using a cryptographic method. Each data block includes information of a batch of network transactions, the information being used for verifying the validity of information of the data block (anti-counterfeiting) and generating a next data block. The blockchain may include an underlying blockchain platform, a platform product service layer, and application service layer.

The underlying blockchain platform may include user management, basic service, smart contract, operation monitoring, and other processing modules. The user management module is responsible for identity information management of all blockchain participants, including maintaining public-private key generation (account management), key management, maintaining a correspondence between the real identity of a user and a blockchain address (permission management), and the like, supervising and auditing transaction conditions of some real identities with authorization, and providing rule configuration of risk control (risk control auditing). The user management module may also be responsible for processing a request for becoming a consortium node, verifying qualification of a consortium node, and issuing a consortium node certificate to a node device. The basic service module is deployed on all blockchain node devices and configured to verify the validity of a service request, and after a consensus is reached on a valid request, record the valid request in storage. For a new service request, the basic service module first parses interface adaptation and performs authentication processing (interface adaptation), then encrypts service information by using a consensus algorithm (consensus management), transmits the perform and consistent service information after encryption to a shared ledger (network communication), and performs recording and storing. The smart contract module is responsible for contract registration and publication, contract triggering, and contract execution. A developer may define contract logic by using a programming language, and release the contract logic onto a blockchain (contract registration). According to the logic of contract items, a key or another event is invoked to trigger execution, to perform the contract logic. The function of upgrading or canceling a contract is further provided. For example, a transfer ratio between different virtual resources may be set by using a smart contract. The operation supervision module is responsible for deployment, configuration modification, contract setting, and cloud adaptation during product releasing and visualized output of a real-time status during product operation, for example, alarming, monitoring network conditions, and monitoring a health status of a node device.

The platform product service layer provides basic capabilities and implementation frameworks for typical applications. Based on the basic capabilities, the developers may superimpose service characteristics to perform a blockchain implementation of the service logic. The application service layer provides application services based on a blockchain solution for service participants to use.

Consensus mechanism: It is a mathematical algorithm for building trust and obtaining rights and interests between different nodes in a blockchain system. In a blockchain system, a transaction can be verified and confirmed in a short time through voting of special node devices. For a transaction, if several node devices that are irrelevant to each other in terms of interests can reach a consensus, it can be considered that all node devices in the system can also reach a consensus.

Smart contract: It is a computer protocol designed to disseminate, verify, or execute contracts in an information-based manner. A contract program configured to be automatically executed by each node device in the blockchain system according to a particular condition may perform an operation on data stored on the blockchain, and is an important means for users to interact with the blockchain and implement service logic by using the blockchain. The smart contract aims to provide a secure method superior to traditional contracts and reduce other transaction costs associated with contracts, and allows for trusted transactions without a third party. These transactions are traceable and irreversible. The smart contract is triggered by transactions and can read, write, and calculate transaction data on the blockchain, so as to support the operation of various commercial applications. A computerized program configured to automatically execute contract terms recognizes and judges on data information obtained from the outside, and when conditions set by a central node and a consortium node is satisfied, the system is triggered to automatically execute the corresponding contract terms, to implement the provisioning of services, the transfer of currency resources, the transfer of universal virtual resources, and the transfer of institutional virtual resources in the embodiments of the present disclosure. The smart contract in the embodiments of the present disclosure is divided into a general part and a customized part. The general part supports basic functions such as identity authentication, transaction, and virtual resource transfer. The customized part is configured to deal with the differentiated application scenarios of the consortium nodes. The consortium nodes may be configured with independent smart contracts to implement special functions.

Public key and private key: They are a key pair (that is, one public key and one private key) obtained by using an algorithm. The public key is a public part in the key pair, and the private key is a non-public part in the key pair. The public key is usually used for encrypting data or verifying a digital signature. Such an algorithm can ensure that the key pair obtained is unique. When such a key pair is used, data encrypted using one key may be decrypted using the other key. For example, if data is encrypted using the public key, the data may be decrypted using the private key, or if data is encrypted using the private key, the data may be decrypted using the public key. Otherwise, the decryption fails.

The embodiments of the present disclosure provide a blockchain system 100 implemented based on the blockchain technology. The system architecture of the blockchain system will be introduced below.

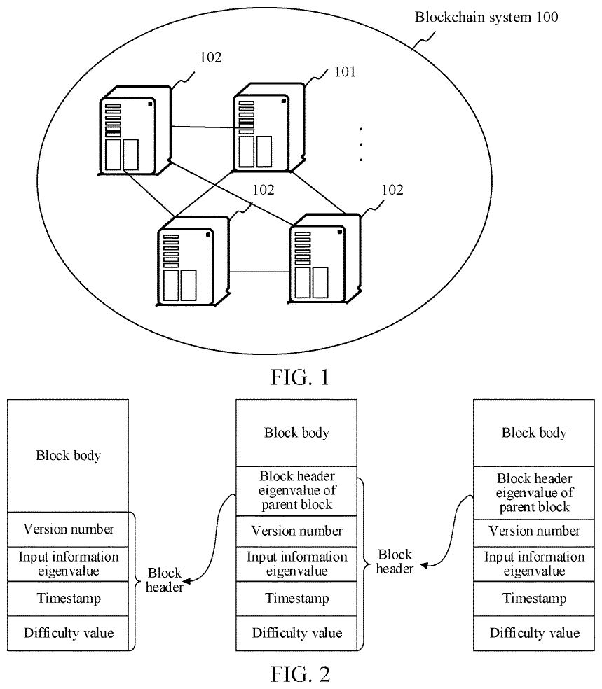

Referring to FIG. 1, the blockchain system may include one central node device 101 and a plurality of node devices 102. In addition, the blockchain system may further include clients.

The central node device 101 and the node devices 102 may be any form of computing devices in a network, such as servers, hosts, user terminals, and so on. The central node device 101 and the node devices 102 can share data. The central node device 101 is configured to generate a universal virtual resource, and services provided by the central node device 101 and the node devices 102 can be obtained by using the universal virtual resource. The node devices 102 are each configured to generate an institutional virtual resource, and the institutional virtual resource can be used to obtain a service from the node device that generates the institutional virtual resource. Based on a peer-to-peer (P2P) protocol, a P2P network may be established between the central node device 101 and the node devices 102. The P2P protocol is an application layer protocol that runs over the Transmission Control Protocol (TCP) protocol.

Each node device 102 can receive input information during normal operation, and maintain shared data in the blockchain system based on the received input information. To ensure the interchange of information in the blockchain system, there may be information connections among the node devices 102 in the blockchain system, and the node devices may transmit information through the information connections. For example, when any node device in the blockchain system receives input information, another node device in the blockchain system obtains the input information according to a consensus algorithm, and stores the input information as data in shared data, so that consistent data is stored in all node devices in the blockchain system.

For each node device 102 in the blockchain system, there is a node device identifier corresponding to the node device. Each node device 102 in the blockchain system stores node device identifiers of other node devices in the blockchain system, to help subsequently broadcast a generated block to other node devices in the blockchain system according to the node device identifiers of other node devices. Each node device 102 may maintain a node device identifier list as shown in Table 1 below, and a node device name and a node device identifier are correspondingly stored in the node device identifier list. The node device identifier may be an Internet Protocol (IP) address and any other type of information that can be used to identify the node device. Table 1 only uses the IP address as an example for description.

TABLE 1

| Node device name | Node device identifier |
|---|---|
| Node device 1 | 117.114.151.174 |
| Node device 2 | 117.116.189.145 |
| . . . | . . . |
| Node device N | 119.123.789.258 |

Each node device in the blockchain system stores the same blockchain. The blockchain includes a plurality of blocks. Referring to FIG. 2, the blockchain includes a plurality of blocks. A genesis block includes a block header and a block body. The block header stores an input information feature value, a version number, a timestamp, and a difficulty value, and the block body stores input information. A next block of the genesis block uses the genesis block as a parent block, and the next block also includes a block header and a block body. The block header stores an input information feature value of a current block, a block header feature value of the parent block, a version number, a timestamp, and a difficulty value. By analogy, block data stored in each block in the blockchain is associated with block data stored in the parent block, thereby ensuring the security of the input information in the blocks.

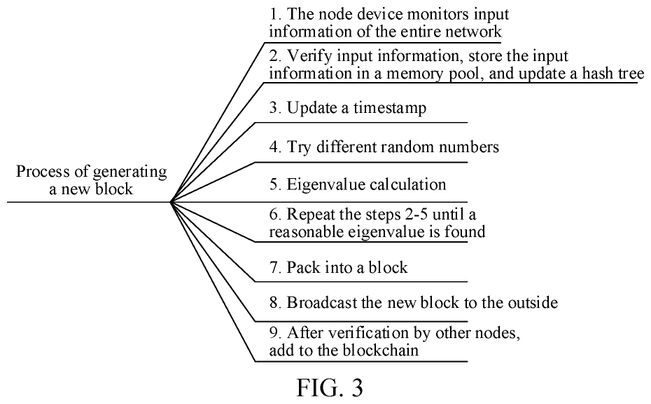

When or in response to determining that each block in the blockchain is generated, referring to FIG. 3, when a node device in which the blockchain is located receives the input information, the node verifies the input information; after the verification is performed, stores the input information in a memory pool, and updates a hash tree used for recording the input information; and then, updates an updated timestamp the time when the input information is received, tries different random numbers, and performs feature value calculation a plurality of times, so that the calculated feature value may meet the following formula:

SHA 256 (SHA 256 (version+prev_hash+merkle_root+ntime+nbits+x))<TARGET

SHA256 is an eigenvalue algorithm used for calculating an eigenvalue; version (a version number) is version information of the related block protocol in the blockchain; prev_hash is a block header eigenvalue of the parent block of the current block; merkle_root is an eigenvalue of inputted information; ntime is the update time of updating a timestamp; nbits is current difficulty, and is a fixed value within a period of time and is redetermined after the fixed period of time; and x is a random number; and TARGET is an eigenvalue threshold. The eigenvalue threshold may be determined and obtained according to nbits.

In this way, when a random number satisfying the above formula is obtained through calculation, information may be correspondingly stored, and a block header and a block body are generated, to obtain a current block. Subsequently, the node device where the blockchain is located transmits, according to the node device identifiers of other node devices in the blockchain system, a newly generated block to the other device nodes in the blockchain system in which the node is located, and the other device nodes verify the newly generated block and add the newly generated block after the verification to the blockchain stored in other nodes.

The functional architecture of the node device 102 in the blockchain system is introduced below.

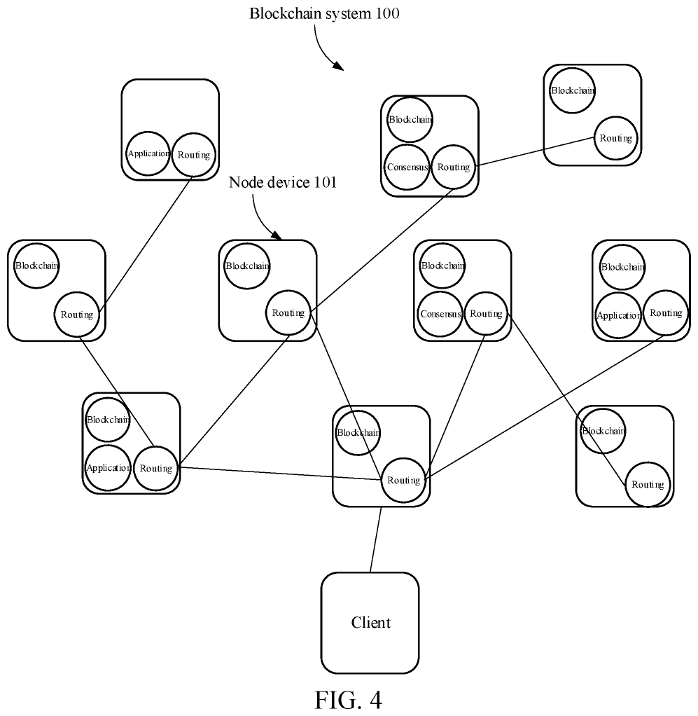

Referring to FIG. 4, the node devices 102 may be divided into a hardware layer, an intermediate layer, an operating system layer, and an application layer according to functions. The specific functions involved may be as follows:

(1) Routing: which is a basic function of a node device, and is used for supporting communication between node devices.

In addition to the routing function, the node device may further have the following functions:

(2) Application: which is deployed in a blockchain, and is used for implementing a particular service, recording data related to function implementation to form recorded data, adding a digital signature to the recorded data to indicate a source of task data, and transmitting the recorded data to another node device in the blockchain system, so that the another node device adds the recorded data to a temporary block when verifying a source and integrity of the recorded data.

For example, services implemented by the present disclosure include:

(2.1) Wallet: used for providing a function of transacting with electronic money, including transaction initiation (that is, a transaction record of a current transaction is transmitted to another node device in the blockchain system, and the another node device writes, after verifying the transaction record, data of the transaction record to a temporary block in the blockchain in response to admitting that the transaction is valid). In certain embodiment(s), the wallet further supports querying for remaining electronic money in an electronic money address.

(2.2) Shared ledger: used for providing functions of operations such as storage, query, and modification of account data. Record data of an operation on the account data is transmitted to another node device in the blockchain system. The another node device writes, after verifying that the account data is valid, the record data to a temporary block in response to admitting that the account data is valid, and may further transmit an acknowledgement to the node device initiating the operation.

(2.3) Smart contract: which is a computerized protocol, may be used for executing conditions of a contract, and is implemented by using code that is deployed in the shared ledger and that is configured to be executed when a condition is satisfied. The code is configured to perform an automated transaction, for example, search for a delivery status of goods purchased by a purchaser, and transfer electronic money of the purchaser to an address of a merchant after the purchaser signs for reception of the goods, query a transfer ratio between the universal virtual resources and the institutional virtual resources, or query a transfer ratio between the universal virtual resources and currency resources. In certain embodiment(s), the smart contract is not limited to a contract used for executing a transaction, and may also be a contract used for processing received information.

(3) Blockchain: including a series of blocks that are consecutive in a chronological order of generation. Once a new block is added to the blockchain, the new block is no longer removed. The block records recorded data submitted by the node device in the blockchain system, for example, a resource transfer record, a resource generation record, etc.

It may be understood that the steps of the method provided in the embodiments of the present disclosure may be executed by a computing device, which includes but is not limited to a server or a terminal. Node devices may also be referred to as computing devices.

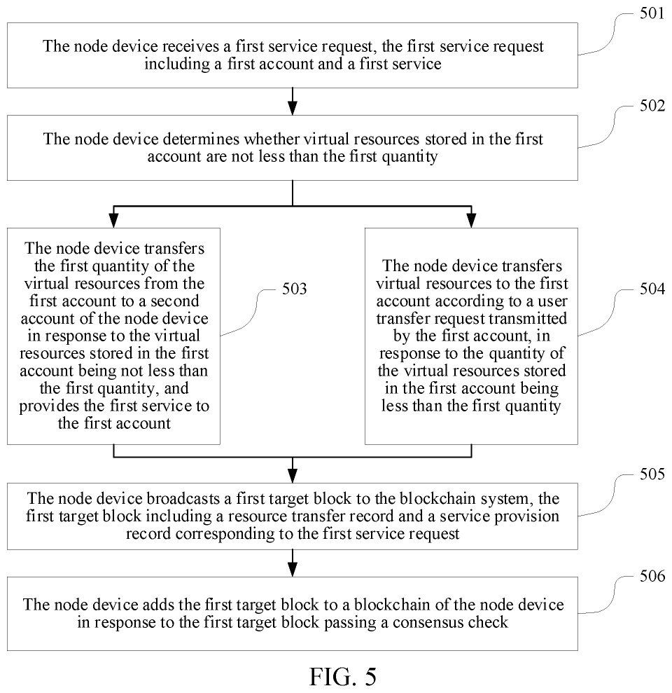

FIG. 5 is a flowchart of a blockchain-based resource transfer method according to an embodiment of the present disclosure. As shown in FIG. 5, in this embodiment of the present disclosure, this method is applied to, for example, a node device in a blockchain system. The blockchain system includes at least two node devices. The blockchain-based resource transfer method includes the following steps:

501. The node device receives a first service request, the first service request including a first account and a first service, and the first service being corresponding to a first quantity of virtual resources.

In the embodiments of the present disclosure, the node device may be a node device configured to provide a service to a user in the blockchain system. A method of transmitting the first service request may be as follows: when a user may use a terminal to purchase a first service provided by a node device, the user may transmit a first service request to the node device through an application client installed on the terminal, where the first service request may carry an account identifier of a first account and a service identifier of the first service. The node device may determine the first account and the first service respectively based on the account identifier and the service identifier.

502. The node device determines whether virtual resources stored in the first account are not less than the first quantity.

In the embodiments of the present disclosure, the first service provided by the node device may be obtained by the user by using an equivalent quantity of virtual resources, and the virtual resource includes one or both of an institutional virtual resource and a universal virtual resource. The institutional virtual resource is generated by a node device. When generating institutional virtual resources, the node devices may transfer, to a central node device in the blockchain system, universal virtual resources of the same value as the institutional virtual resources to be generated. The universal virtual resources of the same value may be an amount of universal virtual resources that is proportional to the amount of institutional virtual resources. The universal virtual resources are generated by the central node device and can be obtained by transferring a corresponding amount of currency resources to the central node device or a node device. The virtual resources stored in the first account may be obtained by the first account from a node device or the central node device by using currency resources. For example, the first account transfers a certain amount of currency resources to the node device to obtain institutional virtual resources generated by the node device and transferred from the node device to the first account; and the first account obtains universal virtual resources transferred from the central node device to the first account by transferring currency resources to the central node device.

In certain embodiment(s), the step of generating institutional virtual resources by the node device may be as follows: the node device may transmit a generation request to the central node device, where the generation request includes a second transfer quantity of the institutional virtual resources to be generated and an additional issuance multiple. The node device may transfer a third transfer quantity of the universal virtual resources to a third account of the central node device according to a generation response including a first transfer ratio that is returned by the central node device, and generating the second transfer quantity of the institutional virtual resources, where the first transfer ratio is used for indicating an exchange ratio of the universal virtual resource to the institutional virtual resource, and the second transfer quantity is equal to a product of the third transfer quantity, the first transfer ratio, and the additional issuance multiple. The node device may store the generation request, the generation response, a transfer record of the third transfer quantity of the universal virtual resources, and a generation record of the second transfer quantity of the institutional virtual resources in the memory pool of the node device.

Because the node device may transfer a certain amount of universal virtual resources to the central node device in order to generate institutional virtual resources, the node device cannot generate institutional virtual resources at will, so the institutional virtual resources have a value property. In addition, due to the existence of the additional issuance multiple, the node device can generate a large number of institutional virtual resources for circulation, to avoid the problem of poor circulation of institutional virtual resources due to the fact that institutional virtual resources deposited in users' accounts are not circulated, thereby increasing the circulation rate of the institutional virtual resources.

For example, when the additional issuance multiple is 1, if the node device intends to generate 100,000 institutional virtual resources, the node device transmits a generation request including a generation quantity of 100,000 and the additional issuance multiple of 1 to the central node device, and then receives a first transfer ratio of 1:50 returned by the central node device, that is, 50 institutional virtual resources can be generated by transferring 1 universal virtual resource. According to the first transfer ratio, the node device may transfer 2,000 universal virtual resources to the third account of the central node device, and then generate 100,000 institutional virtual resources.

For another example, when the additional issuance multiple is 10, if the node device intends to generate 100,000 institutional virtual resources, the node device transmits a generation request including a generation quantity of 100,000 and the additional issuance multiple of 10 to the central node device, and then receives a first transfer ratio of 1:50 returned by the central node device. According to the first transfer ratio, the node device may transfer 200 universal virtual resources to the third account of the central node device, and then generate 100,000 institutional virtual resources.

In certain embodiment(s), the institutional virtual resources stored in the first account may be obtained by transferring currency resources from the first account to the node device. Correspondingly, the step of transferring institutional virtual resources from the first account to the node device by using currency resources may be as follows: In response to receiving a fourth transfer request, the node device may determine the first account indicated in the fourth transfer request and a quantity of to-be-transferred institutional virtual resources indicated in the fourth transfer request. In response to the quantity of institutional virtual resources stored in the second account of the node device satisfying the fourth transfer request, the node device may transfer the quantity of institutional virtual resources indicated in the fourth transfer request from the second account to the first account, and receive currency resources that are transferred by the first account and that are of the same value as the quantity of institutional virtual resources indicated in the fourth transfer request.

In certain embodiments, the term “to-be-transferred virtual resources” and “to-be-transferred institutional virtual resources” are each interchangeable with the term “virtual resources.”

Because the node device provides a way to use currency resources to obtain institutional virtual resources, the user can easily obtain institutional virtual resources at the node device, and the node device can obtain currency resources as income.

In certain embodiment(s), the universal virtual resources stored in the first account may be obtained by transferring currency resources from the first account to the central node device. Correspondingly, the step of transferring universal virtual resources from the first account to the central node by using currency resources may be as follows: In response to receiving a fifth transfer request, the central node device may determine the first account indicated in the fifth transfer request and a quantity of to-be-transferred universal virtual resources indicated in the fifth transfer request. In response to the quantity of universal virtual resources stored in the third account of the central node device satisfying the fifth transfer request, the central node device may transfer the quantity of universal virtual resources indicated in the fifth transfer request from the third account to the first account, and receive currency resources that are transferred by the first account and that are of the same value as the quantity of universal virtual resources indicated in the fifth transfer request.

Because the central node device provides a way to use currency resources to obtain universal virtual resources, the user can easily obtain universal virtual resources at the central node device, and the central node device can obtain currency resources as income.

The institutional virtual resources stored in the first account may be obtained by transferring currency resources from the first account to the node device, or may be obtained by a reward mechanism set by the node device. For example, the institutional virtual resources may be rewarded when currency resources are used to obtain institutional virtual resources, or rewarded when a service is purchased, which is not limited in the embodiments of the present disclosure. Setting of the reward mechanism can increase users' desire to use institutional virtual resources, increase the number of users using institutional virtual resources, and increase the circulation rate of institutional virtual resources.

For example, the node device uses a smart contract to set a transfer ratio of using currency resources to obtain institutional virtual resources to 1:50, that is, 50 institutional virtual resources can be obtained by using 1 currency resource. The reward mechanism set by the node device is that 10 additional institutional virtual resources are rewarded when 10 currency resources are transferred at a time, i.e., the user can obtain 510 institutional virtual resources by transferring 10 currency resources. Alternatively, the reward mechanism set by the node device is that for every 1000 institutional virtual resources consumed, 10 institutional virtual resources are rewarded, i.e., the central node device rewards 10 institutional virtual resources each time the user transfers 1000 institutional virtual resources.

Correspondingly, the universal virtual resources stored in the first account may be obtained by transfer from the central node device to the first account, or may be obtained by a reward mechanism set by the central node device. For example, the universal virtual resources may be rewarded when currency resources are used to obtain universal virtual resources, or rewarded when a service is purchased, which is not limited in the embodiments of the present disclosure. Setting of the reward mechanism can increase users' desire to use universal virtual resources, increase the scope of use of universal virtual resources, and increase the circulation rate of universal virtual resources.

For example, the central node device determines according to a smart contract that a transfer ratio of currency resources to universal virtual resources is 1:1, i.e., 1 universal virtual resource can be obtained by transferring 1 currency resource. The reward mechanism set by the central node device is that 100 additional universal virtual resources are rewarded when 1 currency resources are transferred at a time, i.e., the user can obtain 101 universal virtual resources by transferring 100 currency resources. Alternatively, the reward mechanism set by the central node device is that for every 100 universal virtual resources consumed, 1 universal virtual resource is rewarded, i.e., the central node device rewards 1 universal virtual resources each time the user transfers 100 universal virtual resources.

It may be set that the universal virtual resources rewarded by the central node device can be used to purchase only a service provided by the central node device, or can be used purchase a service provided by any node device.

503. The node device transfers the first quantity of the virtual resources from the first account to a second account of the node device in response to the virtual resources stored in the first account being not less than the first quantity, and provides the first service to the first account.

In the embodiments of the present disclosure, when the condition for obtaining the first service is met, if the first service can be obtained by using different types of virtual resources, the node device may determine to-be-transferred virtual resources according to a transfer sequence set by the first account, where the to-be-transferred virtual resource includes at least one of the institutional virtual resource or the universal virtual resource; transfer a second quantity of the to-be-transferred virtual resources from the first account to the second account of the node device, where the second quantity is a quantity of the to-be-transferred virtual resources corresponding to the first service; and if the first service can be obtained by using only one of the institutional virtual resource or the universal virtual resource, the node device may transfer, according to the type of virtual resource corresponding to the first service, virtual resources of the same type from the first account to the second account.

In certain embodiment(s), information about the transfer sequence of the account may be set by the node device. Correspondingly, the step of setting the information about the transfer sequence of the account by the node device may be as follows: The node device receives a first transfer sequence setting request, where the first transfer sequence setting request includes the first account and a first transfer sequence, the first transfer sequence includes use of the institutional virtual resources for transfer, or, the first transfer sequence includes use of the universal virtual resources for transfer; and sets the transfer sequence of the first account to the first transfer sequence. Alternatively, the node device may set, during creation of the first account, the transfer sequence of the first account to using a default resource type for transfer. The default resource type may be the institutional virtual resource or the universal virtual resource. By setting a resource type to be used for the account, the user can use different resource types for transfer at will, which meets the needs of users to transfer using multiple resource types. In addition, after the user sets the resource type to be used, the user may not choose the type of virtual resource to be used during transfer, which shortens the transfer time and improves the transfer efficiency.

In certain embodiment(s), when the first account uses institutional virtual resources for transfer, the step of transferring a second quantity of the to-be-transferred virtual resources from the first account to the second account of the node device by the node device may be as follows: the node device may acquire a quantity of the institutional virtual resources stored in the first account in response to the transfer sequence of the first account being using the institutional virtual resources for transfer. In response to the quantity of institutional virtual resources stored in the first account being not less than the quantity of institutional virtual resources corresponding to the first service, the node device may transfer the same quantity of institutional virtual resources as the quantity of institutional virtual resources corresponding to the first service from the first account to the second account of the node device. By setting the first account to use institutional virtual resources for transfer, there may not be a need to ask the user which type of virtual resource is to be used for transfer, which shortens the transfer time and improves the transfer efficiency.

For example, the first account stores 10 universal virtual resources and 100 institutional virtual resources, the node device can provide a service A, and the service A can be obtained by transferring 50 institutional virtual resources or 1 universal virtual resource to the node device. The user transmits a service request indicating the service A to the node device by using a user terminal. Because the virtual resources stored in the first account meet the condition for obtaining the service A and the first account uses institutional virtual resources for transfer, the node device transfers 50 institutional virtual resources from the first account to the second account, and provides the service A to the first account.

In certain embodiment(s), when the first account uses universal virtual resources for transfer, the step of transferring a second quantity of the to-be-transferred virtual resources from the first account to the second account of the node device by the node device may be as follows: the node device may acquire a quantity of the universal virtual resources stored in the first account in response to the transfer sequence of the first account being using the universal virtual resources for transfer. In response to the quantity of universal virtual resources stored in the first account being not less than the quantity of universal virtual resources corresponding to the first service, the node device may transfer the same quantity of institutional virtual resources as the quantity of universal virtual resources corresponding to the first service from the first account to the second account of the node device. By setting the first account to use universal virtual resources for transfer, there may not be a need to ask the user which type of virtual resource is to be used for transfer, which shortens the transfer time and improves the transfer efficiency.

For example, the first account stores 10 universal virtual resources and 100 institutional virtual resources, the node device can provide a service B, and the service B can be obtained by using 100 institutional virtual resources or 2 universal virtual resources. The user transmits a service request indicating the service B to the node device by using a user terminal. Because the virtual resources stored in the first account meet the condition for obtaining the service A and the first account uses universal virtual resources for transfer, the node device transfers 2 universal virtual resources from the first account to the second account, and provides the service B to the first account.

In certain embodiment(s), if the quantity of resources of the type to be used by the first account is insufficient to obtain the first service, the node device may deduct resources of another type from the first account. Correspondingly, the step of transferring a second quantity of the to-be-transferred virtual resources from the first account to the second account of the node device by the node device may be as follows: The node device may acquire a quantity of the universal virtual resources corresponding to the first service in response to the quantity of the institutional virtual resources stored in the first account being less than the quantity of the institutional virtual resources corresponding to the first service. In response to the quantity of universal virtual resources stored in the first account being not less than the quantity of universal virtual resources corresponding to the first service, the node device may transfer the same quantity of institutional virtual resources as the quantity of universal virtual resources corresponding to the first service from the first account to the second account, where the universal virtual resources stored in the first account are obtained by transferring currency resources from the first account to the central node device. The node device may store a transfer record of the universal virtual resources corresponding to the first service in a memory pool of the node device. Because the virtual resources stored in the first account meet the condition for obtaining the first service, when the quantity of virtual resources of the type to be used is insufficient, other types of virtual resources may be used for transfer, to ensure that the first account can obtain the first service.

For example, the first account stores 10 universal virtual resources and 100 institutional virtual resources, the node device can provide a service C, and the service C can be obtained by using 150 institutional virtual resources or 3 universal virtual resources. The user transmits a service request indicating the service C to the node device by using a user terminal. Because the virtual resources stored in the first account meet the condition for obtaining the service C, the first account uses institutional virtual resources for transfer, but the quantity of institutional virtual resources stored in the first account is insufficient to obtain the service C, the node device transfers 3 universal virtual resources from the first account to the second account, and provides the service C to the first account.

When the virtual resources stored in the first account meet the condition for obtaining the first service but the quantity of virtual resources of any resource type is insufficient to obtain the first service, the node device may use two or more types of virtual resources in combination for transfer, deduct virtual resources of the type to be used from the first account, and then deduct virtual resources of another resource type, so that the total quantity of virtual resources deducted is insufficient to obtain the first service.

Virtual resources having a target attribute that are rewarded to the user can only be used to obtain a service provided by the node device. The target attribute includes at least one of being obtained as a reward, having a validity period, and being used for obtaining the first service. The node device may deduct the rewarded virtual resources. Correspondingly, the step of transferring a second quantity of the to-be-transferred virtual resources from the first account to the second account of the node device by the node device may be as follows: In response to the first account including virtual resources having the target attribute, the node device may transfer the virtual resources having the target attribute from the first account. By transferring universal virtual resources having the target attribute, the user can get the maximum discount, thereby improving user experience.

For example, there are three universal virtual resources rewarded by a node device in the first account, which can be used to purchase a service provided by the node device, but cannot be used to obtain a service provided by any other node device. If the quantity of universal virtual resources corresponding to the service provided by the node device is 4, the node device may transfer the rewarded 3 universal virtual resources first, and then transfer 1 other universal virtual resource.

504. The node device transfers virtual resources to the first account according to a user transfer request transmitted by the first account, in response to the quantity of the virtual resources stored in the first account being less than the first quantity.

In the embodiments of the present disclosure, the node device may acquire an institutional virtual resource difference between a quantity of the institutional virtual resources corresponding to the first service and a quantity of the institutional virtual resources stored in the first account in response to the quantity of the virtual resources stored in the first account being less than the first quantity. Then, the node device may return first prompt information including the institutional virtual resource difference to the first account (a client that the first account is logged in to). The first prompt information may be used for prompting the quantity of institutional virtual resources that the user may obtain. In response to receiving a user transfer request transmitted by the first account, the node device may transfer a first transfer quantity of the institutional virtual resources indicated in the user transfer request from the second account to the first account, and receive the universal virtual resources or currency resources that correspond to the first transfer quantity of the institutional virtual resources and that are transferred from the first account to the second account. The first transfer quantity is not less than the institutional virtual resource difference. Afterward, the node device may transfer the same quantity of institutional virtual resources as the quantity of institutional virtual resources corresponding to the first service from the first account to the second account of the node device. The node device may store the user transfer request, a transfer record of the first transfer quantity of the institutional virtual resources, and a transfer record of the universal virtual resources or the currency resources that correspond to the first transfer quantity of the institutional virtual resources in a memory pool of the node device. The above process is equivalent to that the node device also provides a service of transferring institutional virtual resources. Because institutional virtual resources are generated by a node device and can be transferred only at the node device that generates the institutional virtual resources, the institutional virtual resources can be circulated between the user and the node device.

For example, the first account stores 10 universal virtual resources, 100 institutional virtual resources, and 100 currency resources, the node device can provide a service D, and the service D can be obtained by using 1000 institutional virtual resources or 20 universal virtual resources. Because the virtual resources stored in the first account do not meet the condition for obtaining the service D, the node device may determine that another 900 institutional virtual resources are needed. The node device returns prompt information to the first account to prompt the user that another 900 institutional virtual resources are needed. After receiving the prompt information, the user may transmit a user transfer request by using the first account, where the user transfer request instructs to transfer 2000 institutional virtual resources. The node device may transfer 2000 institutional virtual resources to the first account and receive 40 currency resources transferred from the first account to the second account. In certain embodiment(s), if the first account obtains 30 universal virtual resources by transferring 30 currency resources to the central node device before transmitting the user transfer request, the first account may transfer 40 universal virtual resources to the second account to obtain 2000 institutional virtual resources.

505. The node device broadcasts a first target block to the blockchain system, the first target block including a resource transfer record and a service provision record corresponding to the first service request.

In the embodiments of the present disclosure, the node device in the blockchain generates a corresponding transfer record when a resource transfer occurs. The node device may aggregate at least one transfer record into resource transfer information, and broadcast the resource transfer information to the blockchain system. Any node device can receive resource transfer information transmitted by other node devices in the blockchain system, to ensure that memory pools of all the node devices in the blockchain system store the same resource transfer information.

Because the node device stores the resource transfer information such as a generation record of institutional virtual resources, a transfer record of institutional virtual resources, a transfer record of universal virtual resources, and a receipt record of currency resources in the memory pool of the node device, the node device may further pack the resource transfer information stored in the memory pool to generate a first target block when elected as an accounting node, and then broadcast the first target block to the blockchain system. The node device performs the operation of packing the resource transfer information stored in the memory pool into a block at intervals of a certain period of time, e.g., every 1 minute, every 10 minutes, or every 30 minutes.

506. The node device adds the first target block to a blockchain of the node device in response to the first target block passing a consensus check.

In the embodiments of the present disclosure, the structure and description of the target block may be as shown in Table 2. The target block may include a block size, a transaction counter, a block header, and a block body. When a resource is transferred, it is considered that a transaction has occurred, so the quantity of transactions may be equivalent to the quantity of transfer records.

TABLE 2

| Field | Description |
|---|---|
| Block size | Size of the block after this field in bytes |
| Transaction counter | Quantity of transactions contained in the block |
| Block header | Several fields that constitute the block header |
| Block body | Transaction information recorded in the block |

The structure and description of the block header may be as shown in Table 3. The block header includes a block version number, a hash value of a parent block header, a hash value of a Merkel root, a timestamp, and a Nonce (Number used once). The structure and description of the block body may be as shown in Table 4. The block body includes a version, an input counter, an input, an output counter, an output, a lock time, a transaction duration, a signature, a hash value, a smart contract ID, a smart contract input, and a smart contract output.

TABLE 3

| Field | Description |
|---|---|
| Block version | Current block version number |
| number | |
| Hash value of parent | Hash value of previous block header |
| block header | |
| Hash of Merkel root | Hash of Merkel root generated by a transaction list |
| Timestamp | Approximate time generated by the block; |
| | UNIX time precise to seconds |
| Nonce | Random values used in the process of generating |
| | a block by the central node device |

TABLE 4

| Field | Description |
|---|---|
| Version | Version number |
| Input counter | Quantity of transaction inputs included |
| Input | One or more transaction inputs |
| Output counter | Quantity of transaction outputs included |
| Output | One or more transaction outputs |
| Lock time | Timestamp |
| Transaction market | Time taken to perform the transaction |
| Signature | Signatures of transaction initiator, |
| | central node device, and node device |
| Hash value | Hash pointer pointing to a transaction being spent |
| Smart contract | Smart contract event triggered |
| identifier | |
| Smart contract input | Call the interface and input of the smart contract |
| Smart contract output | Call the output of the smart contract |

The node device may also exchange institutional virtual resources for universal virtual resources through the central node device. Correspondingly, the step of exchanging institutional virtual resource for universal virtual resource by the node device may be as follow: The node device may transmit a first transfer request to the central node device in the blockchain system, where the first transfer request includes a fourth transfer quantity of the institutional virtual resources to be transferred. The node device may destruct the fourth transfer quantity of the institutional virtual resources from the second account according to a first transfer response including a second transfer ratio that is returned by the central node device, and receive a fifth transfer quantity of the universal virtual resources transferred from a third account of the central node device to the second account, where the second transfer ratio is generated by the central node device according to a current risk level of the node device, the second transfer ratio is used for indicating an exchange ratio of the institutional virtual resources to the universal virtual resources, and the fifth transfer quantity is equal to a product of the fourth transfer quantity and the second transfer ratio. The node device may store the first transfer request, the first transfer response, a destruction record of the fourth transfer quantity of the institutional virtual resources, and a receipt record of the fifth transfer quantity of the universal virtual resources in the memory pool of the node device. Because the node device pledges universal virtual resources of the equivalent value to the central node device when generating institutional virtual resources, the node device may also destruct the generated institutional virtual resources and receive universal virtual resources of the equivalent value from the central node device. In this way, it can be ensured that the quantity of institutional virtual resource will not be too large, so that the institutional virtual resources have value.

The node device may also exchange universal virtual resources for currency resources through the central node device. Correspondingly, the step of changing universal virtual resources for currency resource by the node device may be as follows: The node device may transmit a second transfer request to the central node device in the blockchain system, where the second transfer request includes a sixth transfer quantity of the universal virtual resources to be transferred. The node device may transfer the sixth transfer quantity of the universal virtual resources from the second account to a third account of the central node device according to a second transfer response including a third transfer ratio that is returned by the central node, and receiving a seventh transfer quantity of currency resources transferred by the central node device from the third account to the second account, where the third transfer ratio is used for indicating an exchange ratio of the universal virtual resources to the currency resources, and the seventh transfer quantity is equal to a product of the sixth transfer quantity and the third transfer ratio. The node device may store the second transfer request, the second transfer response, a transfer record of the sixth transfer quantity of the universal virtual resources, and a receipt record of the seventh transfer quantity of the currency resources in the memory pool of the node device. Because the node device can exchange institutional virtual resources for universal virtual resources through the central node device and can receive the universal virtual resources transferred to the node device by the user who obtains the service provided by the node device, the node device can store a large quantity of universal virtual resources, and exchange the universal virtual resources for currency resources, so that virtual resources and physical resources can be exchanged between each other, thereby improving the resource transfer system.

In the embodiments of the present disclosure, by using the blockchain system, each merchant has a corresponding node device on the blockchain system. There are two types of virtual resources in the blockchain system: institutional virtual resources and universal virtual resources. The institutional virtual resources are generated by the node devices of the merchants, and the universal virtual resources are generated by a central node of the blockchain system. A user may transfer institutional virtual resources or universal virtual resources to a node device to obtain a service provided by the node device. The user may transfer a certain quantity of institutional virtual resources to the node device according to a transfer ratio to obtain universal virtual resources transferred from the node device to an account of the user. In this way, the user can exchange institutional virtual resources of one merchant for universal virtual resources, and then exchange the universal virtual resources for institutional virtual resources of the node device of another merchant, thereby realizing the exchange of virtual resources of different merchants. Moreover, each time when a virtual resource transfer occurs in the blockchain system, each node will store a record of the virtual resource transfer. Therefore, each node stores the virtual resource storage status of each user account, and a node device can perform a virtual resource transfer without having to exchange data with the node device of any other merchant, which simplifies the data processing steps and data transmission times for transferring virtual resources, improves the efficiency, and reduces the costs of merchants in maintaining their virtual resource systems.

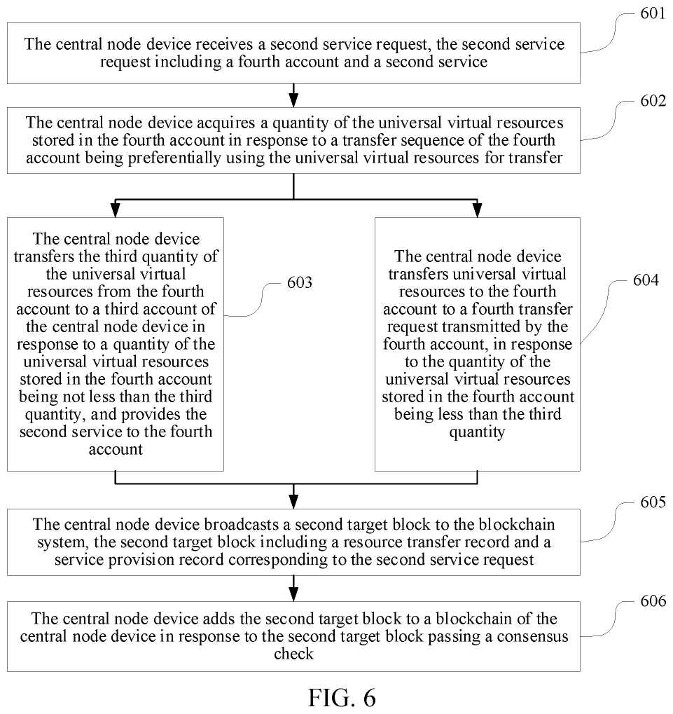

The embodiment shown in FIG. 5 is an embodiment described from the perspective of the node device in the blockchain system, and the following description is given from the perspective of the central node device in the blockchain system. FIG. 6 is a flowchart of another blockchain-based resource transfer method according to an embodiment of the present disclosure. As shown in FIG. 6, in this embodiment of the present disclosure, this method is applied to, for example, a central node device in a blockchain system. The blockchain-based resource transfer method includes the following steps:

601. The central node device receives a second service request, the second service request including a fourth account and a second service, and the second service being corresponding to a third quantity of universal virtual resources.

In the embodiments of the present disclosure, the central node device is a node device configured to generate universal virtual resources in the blockchain system. The central node device may further be configured to provide a service to a user or other node devices. A method of transmitting the second service request may be as follows: when a user or merchant may purchase a second service provided by the central node device, the user or merchant may transmit a second service request to the central node device through a client or a merchant backend, where the second service request may carry an account identifier of a fourth account and a service identifier of the second service. The node device may determine the fourth account and the second service respectively based on the account identifier and the service identifier.

The central node device may further be configured to audit another node device that intends to join the blockchain system. Correspondingly, the step of auditing a node device by the central node device may be as follows: Any node device that intends to join the blockchain system may transmit a joining request to the central node device in the blockchain system, where the joining request is used for instructing the node device to request to join the blockchain system. After receiving the joining request, the central node device may audit the node device according to an admission mechanism, where the admission mechanism is configured to audit at least one of legal compliance, service endurance, or computing and processing capabilities of the node device. The use of the audit mechanism to audit the node device that intends to join the blockchain system can ensure that the processing capacity of the node device in the blockchain reach a commercial level, and can also ensure the security and stability of the blockchain system.

After the node device passes the auditing, the central node device may issue an admission certificate to the node device, where the admission certificate is used for indicating that the node device has obtained a grant from the central node device. After the node device obtains the grant, the node device may configure a related service program, and then may be associated with a server corresponding to the node device. After being started, the node device can connect to the blockchain system to provide a service in the blockchain system.

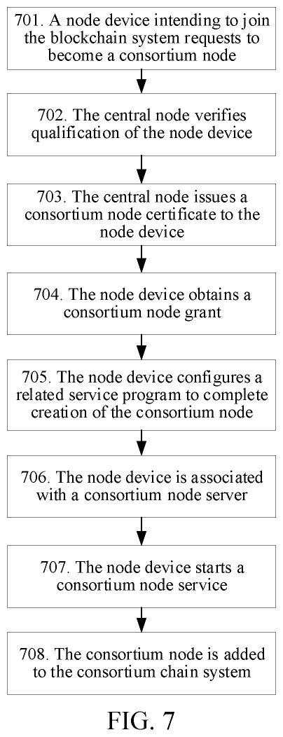

For example, the blockchain system may be a consortium chain system, the central node device may be a central node in the consortium chain system, and the node device that intends to join the blockchain system may be a consortium node in the consortium chain system. The process of auditing the consortium node by the central node may be as shown in FIG. 7. FIG. 7 is a flowchart showing auditing of a consortium node by a central node according to an embodiment of the present disclosure. In step 701, the node device that intends to join the blockchain system requests to become a consortium node. In step 702, the central node verifies whether the node device is qualified to become a consortium node. In step 703, after the node device passes the verification, the central node issues a consortium node certificate to the node device. In step 704, the node device obtains a grant from the consortium node. In step 705, the node device configures a related service program to perform creation of the consortium node. In step 706, the node device is associated with a consortium node server. In step 707, the node device starts to serve as a consortium node. In step 708, the consortium node is added into the consortium chain system.

602. The central node device acquires a quantity of the universal virtual resources stored in the fourth account in response to a transfer sequence of the fourth account being using the universal virtual resources for transfer.

The service provided by the central node cannot be obtained by using virtual resources other than universal virtual resources, but can be obtained by using currency resources. Therefore, the central node device can implement the transfer according to the transfer sequence set by the fourth account.

In certain embodiment(s), the transfer sequence of the account may be set by the central node device. Correspondingly, the step of setting the transfer sequence of the account by the central node device may be as follows: The central node device sets, in response to receiving a second transfer sequence setting request, the transfer sequence of the fourth account indicated in the second transfer sequence setting request to using a resource type indicated in the second transfer sequence setting request for transfer. Alternatively, the central node device may set, during creation of the fourth account, the transfer sequence of the fourth account to using a default resource type for transfer. The default resource type may be the universal virtual resource or the currency resource. By setting a resource type to be used for the account, the user can use different resource types for transfer at will, which meets the needs of users to transfer using multiple resource types. In addition, after the user sets the resource type to be used, the user may not choose the type of resource to be used during transfer, which shortens the transfer time and improves the transfer efficiency.

603. The central node device transfers the third quantity of the universal virtual resources from the fourth account to a third account of the central node device in response to a quantity of the universal virtual resources stored in the fourth account being not less than the third quantity, and provides the second service to the fourth account.

In the embodiments of the present disclosure, the service provided by the central node device may be transferred by using universal virtual resources of the equivalent value. The universal virtual resources stored in the fourth account are transferred from the central node device to the fourth account. The manner in which the fourth account obtains the universal virtual resources is the same as the manner in which the first account obtains the universal virtual resources in step 502, so the details will not be repeated here.

604. The central node device transfers universal virtual resources to the fourth account to a fourth transfer request transmitted by the fourth account, in response to the quantity of the universal virtual resources stored in the fourth account being less than the third quantity.

In the embodiments of the present disclosure, when the universal virtual resources stored in the fourth account of the central node device are insufficient to obtain the second service, a universal virtual resource difference between the quantity of universal virtual resources corresponding to the second service and the quantity of universal virtual resources stored in the fourth account may be determined. Then, the central node device may return second prompt information including the universal virtual resource difference to the fourth account. The second prompt information may be used for prompting the quantity of universal virtual resources that the user may obtain. The central node device may generate, in response to receiving a third transfer request transmitted by the fourth account, an eighth transfer quantity of the universal virtual resources indicated in the third transfer request. The central node device may transfer the eighth transfer quantity of the universal virtual resources from the third account to the fourth account, and receive currency resources or the institutional virtual resources that are of the same value as the eighth transfer quantity of the universal virtual resources and that are transferred from the fourth account to the third account, where the eighth transfer quantity is not less than the universal virtual resource difference. The central node device may transfer the same quantity of institutional virtual resources as the quantity of universal virtual resources corresponding to the second service from the fourth account to the third account of the central node device. The central node device may store the third transfer request, a generation record and a transfer record of the eighth transfer quantity of the universal virtual resources, and a transfer record of the currency resources or the institutional virtual resources that are of the same value as the eighth transfer quantity of the universal virtual resources in a memory pool of the central node device.

For example, the fourth account stores 10 universal virtual resources, 100 institutional virtual resources, and 100 currency resource, the central node device can provide a service E, and the service E can be obtained by using 20 universal virtual resources. Because the universal virtual resources stored in the fourth account are insufficient to obtain the service E, the central node device may determine that the universal virtual resource difference is 10. The central node device returns prompt information to the fourth account to prompt the user that another 10 universal virtual resources are needed. After receiving the prompt information, the user may transmit a third transfer request by using the fourth account, where the third transfer request instructs to transfer 10 universal virtual resources. The central node device may generate 10 universal virtual resources, then transfer 10 universal virtual resources to the fourth account, and receive 10 currency resources transferred from the fourth account to the third account. In this way, the fourth account stores 20 universal virtual resources, 100 institutional virtual resources, and 90 currency resources, and can obtain provide sufficient universal virtual resources for obtaining the service E.

605. The central node device broadcasts a second target block to the blockchain system, the second target block including a resource transfer record and a service provision record corresponding to the second service request.

Step 605 is similar to the step 505, so the details will not be described herein again.

606. The central node device adds the second target block to a blockchain of the central node device in response to the second target block passing a consensus check.

Step 606 is similar to the step 506, so the details will not be described herein again. Exemplarily, when the first service request is the same as the second service request, the first target block is the same as the second target block.

The central node device may further instruct another node device to generate institutional virtual resource according to a generation request transmitted by the another node device. The central node device may determine a first transfer ratio for exchanging the universal virtual resources for the institutional virtual resources in response to receiving a generation request transmitted by another node device in the blockchain system, where the generation request includes a second transfer quantity of the institutional virtual resources to be generated by the another node device and an additional issuance multiple. The central node device may return a generation response including the first transfer ratio to the another node device, and receive a third transfer quantity of the universal virtual resources transferred from a second account of the another node device to the third account, where a product of the third transfer quantity and the first ratio is equal to a ratio of the second transfer quantity to the additional issuance multiple. The central node device may store the generation request, the generation response, and a transfer record of the third transfer quantity of the universal virtual resources in the memory pool of the central node device.

The central node device may adjust the maximum additional issuance multiple of the node device according to an operating status, asset qualification or the like of the node device. The additional issuance multiple carried in the generation request transmitted by the node device is not allowed to exceed the maximum additional issuance multiple set by the central node device for the node device.

Because other node devices can issue additional institutional virtual resources, the circulation of institutional virtual resources is increased, but there is also a risk that the institutional virtual resources cannot be exchanged for universal virtual resources. In order to ensure that the institutional virtual resource will be effectively exchanged for universal virtual resources in a short time, the central node device may adjust in real time an actual transfer ratio for exchanging institutional virtual resources for universal virtual resources according to a time for another node device to exchange the institutional virtual resources for universal virtual resources. The transfer time is inversely proportional to the actual transfer ratio, that is, the longer the transfer time, the lower the actual transfer ratio, and the smaller the number of universal virtual resources that can be obtained by transferring a fixed number of institutional virtual resources. The actual transfer ratio represents a transfer ratio between the quantity of institutional virtual resources and the quantity of universal virtual resources of the equivalent value.

A step of determining the actual transfer ratio for exchanging institutional virtual resources for universal virtual resources by the central node device according to a smart contract may be as follows: For any node device, the central node device may obtain a second transfer ratio for exchanging institutional virtual resources for universal virtual resources that is generated according to a risk level of the node device. The central node device determines a transfer time for the transfer according to a current transfer status of the node device, and determines a loss ratio according to the transfer time. The central node device may use a difference between the second transfer ratio and the loss ratio as the actual transfer ratio. The actual transfer ratio indirectly indicates the risk status of the node device. The lower the actual transfer ratio, the higher the risk of the node device. Therefore, users who hold the institutional virtual resources generated by the node device can supervise the node device, to improve the transfer efficiency of the node device and maintain a high actual transfer ratio. In certain embodiment(s), the actual transfer ratio may be calculated in real time by a connector using an algorithm formula. An influence relationship is established between universal virtual resources and institutional virtual resources by using the connector, to improve the circulation of the universal virtual resources and the institutional virtual resources.

For example, the node device may set a transfer ratio for exchanging universal virtual resources for institutional virtual resources to Y, where Y is greater than 0. The central node device may set a transfer ratio of exchanging institutional virtual resources for universal virtual resources to Z, i.e., the second transfer ratio generated according to the risk level of the node device is Z. The actual transfer ratio is represented by ZZ, and the values of Z and ZZ are in a range of [0, 100%]. Then, when a user changes universal virtual resources for institutional virtual resources through the node device, institutional virtual resources=universal virtual resources×Y. When the node device exchanges institutional virtual resources for universal virtual resources through the central node device, universal virtual resources=institutional virtual resources÷Y×ZZ, and ZZ=Z−N×1%, where N represents the transfer time, and N×1% represents the loss ratio.

In the embodiments of the present disclosure, the central node device generates universal virtual resources, and receives universal virtual resources pledged by the node devices to guide the generation of institutional virtual resources, i.e., merchants are endowed with the ability to edit virtual currencies by their own. In addition, because users can use universal virtual resources to purchase services at the central node device, the universal virtual resources can be efficiently circulated. In this way, the efficiency of matching supply with demand is improved, and because the universal virtual resources can be used as the transfer medium, the merchants may not perform work such as transfer ratio negotiation and virtual resource settlement, thereby reducing the related technological investment and maintenance costs.

FIG. 5 and FIG. 6 above are each a flowchart of a blockchain-based resource transfer method according to an embodiment of the present disclosure. To make the blockchain-based resource transfer method more comprehensible, the following description is given from the perspective of the circulation of universal virtual resources and institutional virtual resources in the blockchain system.

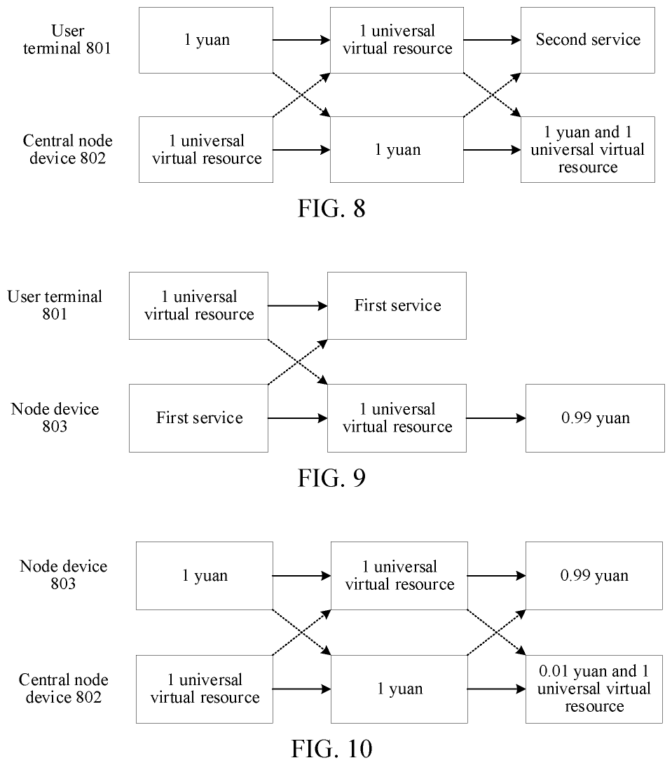

The circulation manner of universal virtual resources may be as shown in FIG. 8 to FIG. 11:

FIG. 8 is a schematic diagram showing circulation of universal virtual resources according to an embodiment of the present disclosure. In FIG. 8, a first account corresponding to a user terminal 801 stores 1 yuan, a third account corresponding to a central node device 802 stores (or the central node device 802 generates) 1 universal virtual resource, and the first account can exchange 1 yuan for 1 universal virtual resource through the central node device 802, to realize the exchange of universal virtual resources with currency resources. After the exchange, the first account stores 1 universal virtual resource, and the third account stores 1 yuan. The first account transfers the stored 1 universal virtual resource to the third account, to obtain a second service (e.g., a virtual commodity, physical commodity, daily life service, etc.) provided by the central node device 802. The central node device 802 obtains the 1 universal virtual resource transferred by the first account. Then, the third account stores 1 yuan and 1 universal virtual resource. In this way, the exchange between currency resources and universal virtual resources and the circulation of universal virtual resources between the third account corresponding to the central node device 802 and the first account corresponding to the user terminal 801 are realized.

FIG. 9 is another schematic diagram showing circulation of universal virtual resources according to an embodiment of the present disclosure. In FIG. 9, a first account corresponding to a user terminal 801 stores 1 universal virtual resource, and a node device 803 provides a first service (e.g., a virtual commodity, physical commodity, daily life service, etc.). The first account transfers the stored 1 universal virtual resource to a second account corresponding to the node device, to obtain the first service provided by the node device 803. The node device 803 obtains the 1 universal virtual resource transferred from the first account. Then, the second account stores 1 universal virtual resource. The node device 803 can exchange the 1 universal virtual resource for 0.99 yuan through any central node device 802.

FIG. 10 is another schematic diagram showing circulation of universal virtual resources according to an embodiment of the present disclosure. In FIG. 10, a second account corresponding to a node device 803 stores 1 yuan, and a third account corresponding to a central node device 802 stores (or the central node device 802 generates) 1 universal virtual resource. The node device 803 exchanges the 1 yuan for 1 universal virtual resource through the central node device 802. Then, the second account corresponding to the node device 803 stores 1 universal virtual resource, and the third account corresponding to the central node device 802 stores 1 yuan. The node device 803 can exchange the 1 universal virtual resource for 0.99 yuan through any central node device 802. Then, the second account corresponding to the node device 803 stores 0.99 yuan. The third account corresponding to the central node device 802 stores 0.01 yuan and 1 universal virtual resource.

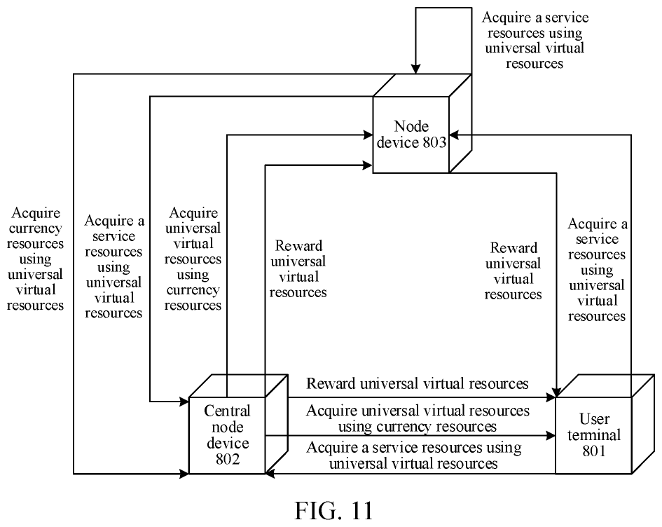

For the circulation manner of universal virtual resources shown in FIG. 8 to FIG. 10, reference may also be made to FIG. 11. FIG. 11 is another schematic diagram showing circulation of universal virtual resources according to an embodiment of the present disclosure. In FIG. 11, directions that arrows point to show a flow direction of universal virtual resources. A central node device 802 may issue universal virtual resources to a user terminal 801 and a node device 803 as rewards, and may also exchange currency resources transferred by the user terminal 801 and the node device 803 for universal virtual resources of the equivalent value. The user terminal 801 may purchase services from the central node device 802 and the node device 803 by transferring universal virtual resources. The node device 803 may reward universal virtual resources to the user terminal 801, may also exchange universal virtual resources for currency resources with the central node device 802, and may also purchase a service from the central node device 802 or another node device in the blockchain system.

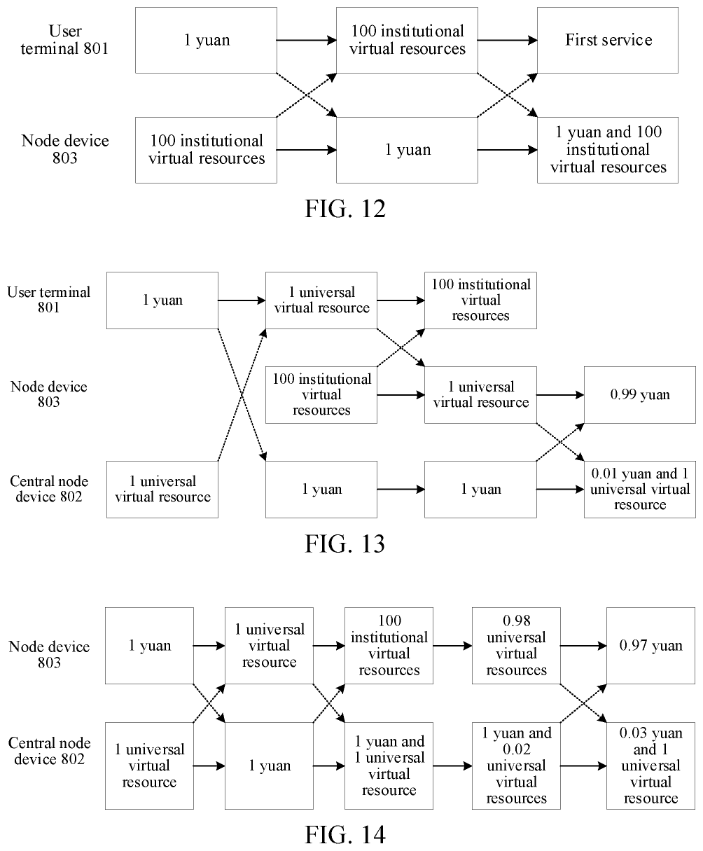

The circulation manner of institutional virtual resources may be as shown in FIG. 12 to FIG. 14:

FIG. 12 is a schematic diagram showing circulation of institutional virtual resources according to an embodiment of the present disclosure. In FIG. 12, a first account corresponding to a user terminal 801 stores 1 yuan. A second account corresponding to a node device 803 stores 100 institutional virtual resources. The user terminal 801 exchanges 1 yuan for 100 institutional virtual resources through the node device 803. Then, the first account stores 100 institutional virtual resources, and the second account stores 1 yuan. The first account transfers the stored 100 institutional virtual resources to the second account, to obtain a first service provided by the node device 803. The node device 803 obtains the 100 institutional virtual resources transferred by the user terminal 801. Then, the second account stores 1 yuan and 100 institutional virtual resources.

FIG. 13 is another schematic diagram showing circulation of institutional virtual resources according to an embodiment of the present disclosure. In FIG. 13, a first account corresponding to a user terminal 801 stores 1 yuan, and a third account corresponding to a central node device 802 stores (or the central node device 802 generates) 1 universal virtual resource. The first account exchanges 1 yuan for 1 universal virtual resource through the central node device 802. Then, the first account stores 1 universal virtual resource, and the third account stores 1 yuan. A second account corresponding to a node device 803 stores 100 institutional virtual resources. The first account exchanges 1 universal virtual resource for 100 institutional virtual resources through the node device 803. Then, the first account stores 100 institutional virtual resources, and the second account stores 1 universal virtual resource. The node device 803 exchanges 1 universal virtual resource for 0.99 yuan through the central node device 802. Then, the third account corresponding to the central node device 802 stores 1 universal virtual resource and 0.01 yuan.

FIG. 14 is another schematic diagram showing circulation of institutional virtual resources according to an embodiment of the present disclosure. In FIG. 14, a second account corresponding to a node device 803 stores 1 yuan, and a third account corresponding to a central node device 802 stores (or the central node device 802 generates) 1 universal virtual resource. The node device 803 exchanges the 1 yuan for 1 universal virtual resource through the central node device 802. Then, the second account corresponding to the node device 803 stores 1 universal virtual resource, and the third account corresponding to the central node device 802 stores 1 yuan. The node device 803 transfers 1 universal virtual resource to the central node device 802 and generates 100 institutional virtual resources. Then, the second account stores 100 institutional virtual resources, and the third account stores 1 yuan and 1 universal virtual resource. Assuming that the actual transfer ratio is 98%, the node device 803 may exchange 100 institutional virtual resources for 0.98 universal virtual resources, i.e., destruct 100 institutional virtual resources. Then, the second account stores 0.98 universal virtual resources, and the third account stores 1 yuan and 0.98 universal virtual resources. The node device 803 exchanges 0.98 universal virtual resources for 0.97 yuan through the central node device 802. Then, the first account stores 0.03 yuan and 1 universal virtual resource.

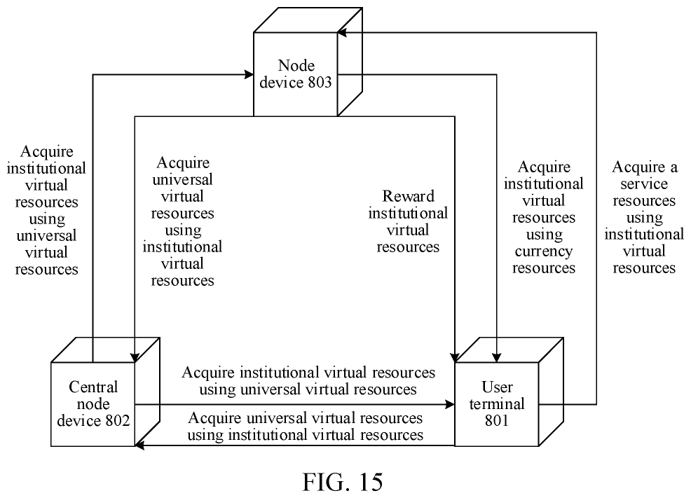

For the circulation manner of institutional virtual resources shown in FIG. 12 to FIG. 14, reference may also be made to FIG. 15. FIG. 15 is another schematic diagram showing circulation of institutional virtual resources according to an embodiment of the present disclosure. In FIG. 15, directions that arrows point to show a flow direction of institutional virtual resources. A user terminal 801 may use institutional virtual resources to purchase a service provided by a node device 803, and may also use institutional virtual resources to transfer universal virtual resources to the node device 803. The node device 803 may reward institutional virtual resources to the user terminal 801, and may also exchange currency resources transferred by the user terminal 801 into institutional virtual resources. In certain embodiment(s), the central node device 802 may also exchange universal virtual resources for institutional virtual resources, i.e., may exchange universal virtual resources for institutional virtual resources of the equivalent value with the user terminal 801 and the node device 803 respectively.

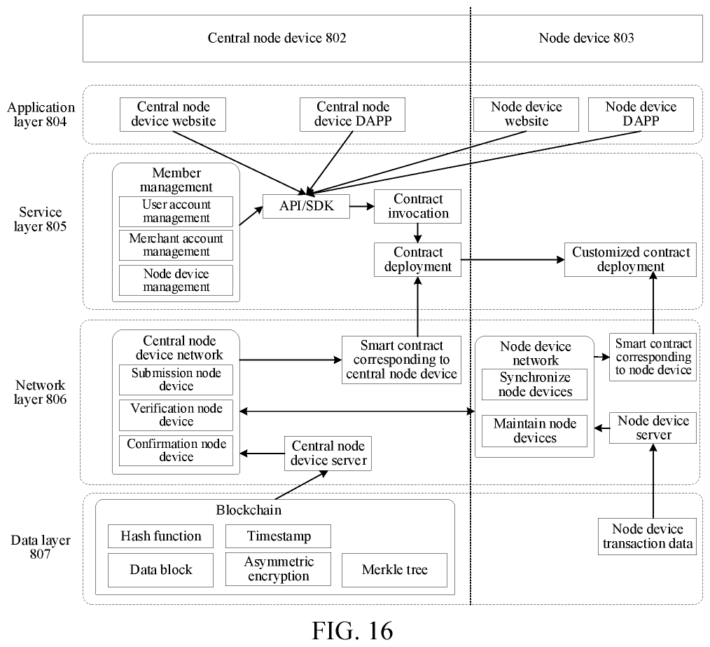

FIG. 16 is a schematic diagram of a double-layer virtual resource network according to an embodiment of the present disclosure. The double-layer virtual resource network is built using blockchain technology to link services and scenarios between different users and merchants to achieve the efficient collaboration between users and merchants in a network through universal virtual resources and institutional virtual resources. The underlying architecture of the double-layer virtual resource network is a blockchain system. The blockchain system includes at least one central node device 802 configured to generate universal virtual resources and at least one node device 803 configured to generate institutional virtual resources. Virtual resources circulating in the double-layer virtual resource network may be universal tokens and derivative tokens. The universal tokens are equivalent to universal virtual resources, and the derivative tokens are equivalent to institutional virtual resources. The double-layer virtual resource network may be referred to as a double-layer token economy network. As shown in FIG. 16, the double-layer virtual resource network includes an application layer 804, a service layer 805, a network layer 806, and a data layer 807. The application layer 804 includes various application programs included with universal tokens or derivative tokens, such as websites, small programs, and decentralized applications (DAPPs). For example, a central node device website, a central node device DAPP, a node device website, a node device DAPP, etc. are included. The central node device 802 may be configured for member management in the service layer 805, including user account management, merchant account management, node device management, node device auditing, and certificate issuance. The service layer 805 may further include multiple application program interfaces (APIs) and an extended software development kit (SDK), and is configured to access logic codes running on the node devices in the network. A smart contract may further be deployed in the service layer 805. The node device 803 may invoke the smart contract in the service layer. The service layer 805 may further be configured to execute various scripts and algorithms. The network layer 806 may include a central node device network composed of at least one central node device, a central node device server, a node device network composed of at least one node device, and a node device server, and is configured to maintain execution of various smart contracts, storage of transaction ledgers, and issuance and distribution of rewards issued by a node device to other node devices. The smart contracts include a smart contract corresponding to the central node device and a smart contract corresponding to the node device. At least one central node device included in the central node device network is classified into a submission node device, a verification node device, and a confirmation node device according to functions. The functions of the central node devices are interchangeable. The central node device network is responsible for verifying transactions and confirming transactions, is responsible for reaching a consensus on the requests of things in the network, generating new blocks, maintaining the blockchain system, and distributing blocks that pass a consensus check to the node device network, and helps ensure the accuracy of transaction data and the consistency of transaction data stored in the central node devices by using a data dissemination mechanism and a data verification mechanism. The node device network is configured to maintain and synchronize the consensus status of each central node device and each node device, keep the transaction data of each central node device and each node device synchronized, and record all the data of each node device. A client program of the node device network may be deployed locally in a node device. The node devices may be classified into synchronization node devices and maintenance node devices according to functions. The data layer 807 is configured to maintain data blocks on various blockchains and transaction data of each node device. The blockchain includes hash functions, timestamps, asymmetric encryption algorithms, Merkel trees, and data blocks. The central node device may include transaction data and related codes received within a period of time into a data block with a time stamp, and add the data block to the end of a main blockchain in chronological order to obtain a new block. The block includes block data, status data, and historical data. A state server is used to provide a query service, to allow a user or service provider to query the current ledger status, i.e., the latest global ledger state in the network. Transaction information between the node devices is recorded in the data block. Each central node device stores the perform blockchain data from a genesis block to the current latest block, performs accounting through data verification and submission of data blocks, dynamically updates the main blockchain. In this way, each central node device can perform the verification of the transaction information and the uploading of the transaction information to the blockchain without reference to other node devices.

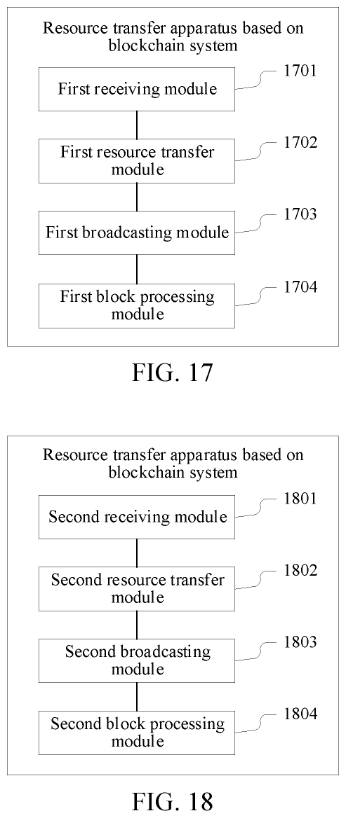

FIG. 17 is a block diagram of a resource transfer apparatus based on a blockchain system according to an embodiment of the present disclosure. The resource transfer apparatus based on a blockchain system is configured to execute the steps of the resource transfer method based on a blockchain system. Referring to FIG. 17, the apparatus is applicable to a node device in the blockchain system and includes: a first receiving module 1701, a first resource transfer module 1702, a first broadcasting module 1703, and a first block processing module 1704.

The first receiving module 1701 is configured to receive a first service request, the first service request including a first account and a first service, and the first service being corresponding to a first quantity of virtual resources.

The first resource transfer module 1702 is configured to transfer the first quantity of the virtual resources from the first account to a second account of the node device in response to a quantity of the virtual resources stored in the first account being not less than the first quantity, and provide the first service to the first account.

The first broadcasting module 1703 is configured to broadcast a first target block to the blockchain system, the first target block including a resource transfer record and a service provision record corresponding to the first service request.

The first block processing module 1704 is configured to add the first target block to a blockchain of the node device in response to the first target block passing a consensus check.

In certain embodiment(s), the first resource transfer module 1702 is further configured to determine to-be-transferred virtual resources according to a transfer sequence of the first account and the quantity of the virtual resources stored in the first account, where the to-be-transferred virtual resource includes at least one of the institutional virtual resource or the institutional virtual resource; and transfer a second quantity of the to-be-transferred virtual resources from the first account to the second account of the node device, where the second quantity is a quantity of the to-be-transferred virtual resources corresponding to the first service.

In certain embodiment(s), the apparatus further includes a first transfer sequence setting module; the first receiving module 1701 is configured to receive a first transfer sequence setting request, where the first transfer sequence setting request includes the first account and a first transfer sequence, the first transfer sequence includes use of the institutional virtual resources for transfer, or, the first transfer sequence includes use of the universal virtual resources for transfer; and the first transfer sequence setting module is configured to set the transfer sequence of the first account to the first transfer sequence; or the first transfer sequence setting module is further configured to set, during creation of the first account, the transfer sequence of the first account to using a default resource type for transfer, where the default resource type is the institutional virtual resource or the universal virtual resource.

In certain embodiment(s), the first resource transfer module 1702 is further configured to acquire a quantity of the institutional virtual resources stored in the first account in response to the transfer sequence of the first account being using the institutional virtual resources for transfer; and determine the institutional virtual resources as the to-be-transferred virtual resources in response to the quantity of the institutional virtual resources stored in the first account being not less than a quantity of the institutional virtual resources corresponding to the first service.

In certain embodiment(s), after the quantity of the institutional virtual resources stored in the first account is determined, the apparatus further includes a first acquiring module and a first record storage module; the first acquiring module is configured to acquire a quantity of the universal virtual resources corresponding to the first service in response to the quantity of the institutional virtual resources stored in the first account being less than the quantity of the institutional virtual resources corresponding to the first service; the first resource transfer module 1702 is further configured to determine the universal virtual resources as the to-be-transferred virtual resources in response to the quantity of the universal virtual resources stored in the first account being not less than the quantity of the universal virtual resources corresponding to the first service, where the universal virtual resources stored in the first account are obtained by transferring currency resources from the first account to the central node device and receiving the universal virtual resources transferred by the central node device; and the first record storage module is configured to store a transfer record of the universal virtual resources corresponding to the first service in a memory pool of the node device.

In certain embodiment(s), the apparatus further includes a first acquiring module, a first information prompting module, and a first record storage module; the first acquiring module is configured to acquire an institutional virtual resource difference between a quantity of the institutional virtual resources corresponding to the first service and a quantity of the institutional virtual resources stored in the first account in response to the quantity of the virtual resources stored in the first account being less than the first quantity; the first information prompting module is configured to return first prompt information including the institutional virtual resource difference to the first account; the first resource transfer module 1702 is configured to, in response to receiving a user transfer request transmitted by the first account, transferring a first transfer quantity of the institutional virtual resources indicated in the user transfer request from the second account to the first account, and receiving the universal virtual resources or currency resources that correspond to the first transfer quantity of the institutional virtual resources and that are transferred from the first account to the second account, where the first transfer quantity is not less than the institutional virtual resource difference; the first resource transfer module 1702 is further configured to transfer a quantity of the institutional virtual resources corresponding to the first service from the first account to the second account of the node device; and the first record storage module is configured to store the user transfer request, a transfer record of the first transfer quantity of the institutional virtual resources, and a transfer record of the universal virtual resources or the currency resources that correspond to the first transfer quantity of the institutional virtual resources in a memory pool of the node device.

In certain embodiment(s), the apparatus further includes a request transmission module and an institutional virtual resource generating module; the request transmission module is configured to transmit a generation request to the central node device, where the generation request includes a second transfer quantity of the institutional virtual resources to be generated and an additional issuance multiple; the institutional virtual resource generating module is configured to transfer a third transfer quantity of the universal virtual resources to a third account of the central node device according to a generation response including a first transfer ratio that is returned by the central node device, and generate the second transfer quantity of the institutional virtual resources, where the first transfer ratio is used for indicating an exchange ratio of the universal virtual resource to the institutional virtual resource, and the second transfer quantity is equal to a product of the third transfer quantity, the first transfer ratio, and the additional issuance multiple; and the first record storage module is further configured to store the generation request, the generation response, a transfer record of the third transfer quantity of the universal virtual resources, and a generation record of the second transfer quantity of the institutional virtual resources in the memory pool of the node device.

In certain embodiment(s), the apparatus further includes a request transmission module; the request transmission module is configured to transmit a second transfer request to the central node device in the blockchain system, where the second transfer request includes a sixth transfer quantity of the universal virtual resources to be transferred; the first resource transfer module 1702 is further configured to transfer the sixth transfer quantity of the universal virtual resources from the second account to a third account of the central node device according to a second transfer response including a third transfer ratio that is returned by the central node, and receive a seventh transfer quantity of currency resources transferred by the central node device from the third account to the second account, where the third transfer ratio is used for indicating an exchange ratio of the universal virtual resources to the currency resources, and the seventh transfer quantity is equal to a product of the sixth transfer quantity and the third transfer ratio; and the first record storage module is further configured to store the second transfer request, the second transfer response, a transfer record of the sixth transfer quantity of the universal virtual resources, and a receipt record of the seventh transfer quantity of the currency resources in the memory pool of the node device.

In certain embodiment(s), the apparatus further includes a request transmission module and an institutional virtual resource destruction module; the request transmission module is configured to transmit a first transfer request to the central node device in the blockchain system, where the first transfer request includes a fourth transfer quantity of the institutional virtual resources to be transferred; the institutional virtual resource destruction module is configured to destruct the fourth transfer quantity of the institutional virtual resources from the second account according to a first transfer response including a second transfer ratio that is returned by the central node device, and receive a fifth transfer quantity of the universal virtual resources transferred from a third account of the central node device to the second account, where the second transfer ratio is generated by the central node device according to a current risk level of the node device, the second transfer ratio is used for indicating an exchange ratio of the institutional virtual resources to the universal virtual resources, and the fifth transfer quantity is equal to a product of the fourth transfer quantity and the second transfer ratio; and the first record storage module is further configured to store the first transfer request, the first transfer response, a destruction record of the fourth transfer quantity of the institutional virtual resources, and a receipt record of the fifth transfer quantity of the universal virtual resources in the memory pool of the node device.

In certain embodiment(s), the apparatus further includes: a first resource packaging module, configured to package resource transfer information stored in a memory pool of the node device to generate the first target block, where the resource transfer information includes the resource transfer record and the service provision record corresponding to the first service request.

In the embodiments of the present disclosure, after the node device pledges a quantity of universal virtual resources to the central node device, an equivalent quantity of institutional virtual resources are generated, i.e., merchants are endowed with the ability to edit virtual currencies by their own. In addition, because users can use institutional virtual resources and universal virtual resources to purchase services at node devices, the virtual resources can be efficiently circulated. In this way, the efficiency of matching supply with demand is improved, and the merchants may not perform work such as transfer ratio negotiation and virtual resource settlement, thereby reducing the related technological investment and maintenance costs.

FIG. 18 is a block diagram of another resource transfer apparatus based on a blockchain system according to an embodiment of the present disclosure. The resource transfer apparatus based on a blockchain system is configured to execute the steps of the resource transfer method based on a blockchain system. Referring to FIG. 18, the apparatus is applicable to a central node device in the blockchain system and includes: a second determining module 1801, a second resource transfer module 1802, a second broadcasting module 1803, and a second block processing module 1804.

The second receiving module 1801 is configured to receive a second service request, the second service request including a fourth account and a second service, and the second service being corresponding to a third quantity of universal virtual resources.

The second resource transfer module 1802 is configured to transfer the third quantity of the universal virtual resources from the fourth account to a third account of the central node device in response to a quantity of the universal virtual resources stored in the fourth account being not less than the third quantity, and provide the second service to the fourth account, the universal virtual resource being generated by the central node device, and the universal virtual resources stored in the fourth account being transferred to the fourth account by the central node device.

The second broadcasting module 1803 is configured to broadcast a second target block to the blockchain system, the second target block including a resource transfer record and a service provision record corresponding to the second service request.

The second block processing module 1804 is configured to add the second target block to a blockchain of the central node device in response to the second target block passing a consensus check.

In certain embodiment(s), the apparatus further includes: a second acquiring module, configured to acquire a quantity of the universal virtual resources stored in the fourth account in response to a transfer sequence of the fourth account being using the universal virtual resources for transfer.

In certain embodiment(s), the apparatus further includes: a second transfer sequence setting module, configured to set, in response to receiving a second transfer sequence setting request, the transfer sequence of the fourth account indicated in the second transfer sequence setting request to using a resource type indicated in the second transfer sequence setting request for transfer; or the second transfer sequence setting module is further configured to set, during creation of the fourth account, the transfer sequence of the fourth account to using a default resource type for transfer.

In certain embodiment(s), the apparatus further includes a second calculation module, a second information prompting module, a universal virtual resource generating module, and a second record storage module; the second calculation module is configured to calculate a universal virtual resource difference between the third quantity and the quantity of the universal virtual resources stored in the fourth account in response to the quantity of the universal virtual resources stored in the fourth account being less than the third quantity; the second information prompting module is configured to return second prompt information including the universal virtual resource difference to the fourth account; the universal virtual resource generating module is configured to generate, in response to receiving a third transfer request transmitted by the fourth account, an eighth transfer quantity of the universal virtual resources indicated in the third transfer request; the second resource transfer module 1802 is configured to transfer the eighth transfer quantity of the universal virtual resources from the third account to the fourth account, and receive currency resources or the institutional virtual resources that are of the same value as the eighth transfer quantity of the universal virtual resources and that are transferred from the fourth account to the third account, where the eighth transfer quantity is not less than the universal virtual resource difference; and the second record storage module is configured to store the third transfer request, a generation record and a transfer record of the eighth transfer quantity of the universal virtual resources, and a transfer record of the currency resources or the institutional virtual resources that are of the same value as the eighth transfer quantity of the universal virtual resources in a memory pool of the central node device.

In certain embodiment(s), the apparatus further includes a second acquiring module and a second record storage module; the second receiving module 1801 is further configured to receive a generation request transmitted by another node device in the blockchain system; the second acquiring module is configured to acquire a first transfer ratio for exchanging the universal virtual resources for the institutional virtual resources in response to receiving a generation request transmitted by another node device in the blockchain system, where the generation request includes a second transfer quantity of the institutional virtual resources to be generated by the another node device and an additional issuance multiple; the second resource transfer module 1802 is further configured to return a generation response including the first transfer ratio to the another node device, and receive a third transfer quantity of the universal virtual resources transferred from a second account of the another node device to the third account, where a product of the third transfer quantity and the first ratio is equal to a ratio of the second transfer quantity to the additional issuance multiple; and the second record storage module is configured to store the generation request, the generation response, and a transfer record of the third transfer quantity of the universal virtual resources in the memory pool of the central node device.

In certain embodiment(s), the apparatus further includes a second acquiring module and a second record storage module; the second acquiring module is configured to acquire a third transfer ratio for exchanging the universal virtual resources for the currency resources in response to receiving a second transfer request transmitted by another node device in the blockchain system, where the second transfer request includes a sixth transfer quantity of the universal virtual resources to be transferred; the second resource transfer module 1802 is further configured to return a second transfer response including the third transfer ratio to the another node device, transfer a seventh transfer quantity of the currency resources from the third account to a second account of the another node device, and receive the sixth transfer quantity of the universal virtual resources transferred by the another node device from the second account to the third account, where the seventh transfer quantity is equal to a product of the sixth transfer quantity and the third transfer ratio; and the second record storage module is configured to store the second transfer request, the second transfer response, a receipt record of the sixth transfer quantity of the universal virtual resources, and a transfer record of the seventh transfer quantity of the currency resources in the memory pool of the central node device.

In certain embodiment(s), the apparatus further includes: a second resource packaging module, configured to package resource transfer information stored in the memory pool of the central node device to generate the second target block, where the resource transfer information includes the resource transfer record and the service provision record corresponding to the second service request.

In the embodiments of the present disclosure, the central node device generates universal virtual resources, and receives universal virtual resources pledged by the node devices to guide the generation of institutional virtual resources, i.e., merchants are endowed with the ability to edit virtual currencies by their own. In addition, because users can use universal virtual resources to purchase services at the central node device, the universal virtual resources can be efficiently circulated. In this way, the efficiency of matching supply with demand is improved, and because the universal virtual resources can be used as the transfer medium, the merchants may not perform work such as transfer ratio negotiation and virtual resource settlement, thereby reducing the related technological investment and maintenance costs.

When the resource transfer apparatus based on a blockchain system provided in the embodiments runs an application program, only an example of division of the functional modules is described, and in actual application, the functions may be implemented by different functional modules as desirable, that is, the internal structure of the apparatus is divided into different functional modules, to implement all or some of the functions described above. In addition, the resource transfer apparatus based on a blockchain system and the resource transfer method based on a blockchain system provided in the embodiments belong to the same conception. For specific implementation processes, reference may be made to the method embodiments, and the details will not be described herein again.

In the embodiments of the present disclosure, the node device may be implemented as a terminal or a computing device. When the node device is implemented as a terminal, the operations of the resource transfer method based on a blockchain may be implemented by the terminal. When the node device is implemented as a computer, the operations of the resource transfer method based on a blockchain may be implemented by the computing device. Alternatively, the operations of the resource transfer method based on a blockchain may be implemented by the interaction between the computing device and the terminal.

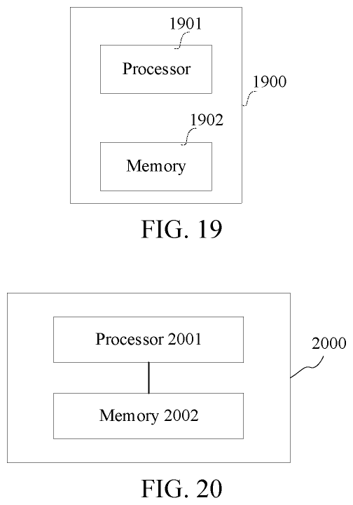

FIG. 19 is a structural block diagram of a terminal 1900 according to an embodiment of the present disclosure. The terminal 1900 may be a smartphone, a tablet computer, a Moving Picture Experts Group Audio Layer III (MP3) player, a Moving Picture Experts Group Audio Layer IV (MP4) player, a notebook computer, or a desktop computer. The terminal 1900 may also be referred to as a user equipment, a portable terminal, a laptop terminal, a desktop terminal, or other names.

Generally, the terminal 1900 includes a processor 1901 and a memory 1902.

The processor 1901 may include one or more processing cores, and may be, for example, a 4-core processor or an 8-core processor. The processor 1901 may be implemented by using at least one hardware form of a digital signal processor (DSP), a field-programmable gate array (FPGA), or a programmable logic array (PLA). The processor 1901 may also include a main processor and a coprocessor. The main processor is a processor configured to process data in an awake state, and is also referred to as a central processing unit (CPU). The coprocessor is a low power consumption processor configured to process data in a standby state. In some embodiments, a graphics processing unit (GPU) may be integrated into the processor 1901. The GPU is configured to be responsible for rendering and drawing content to be displayed on a display. In some embodiments, the processor 1901 may further include an artificial intelligence (AI) processor. The AI processor is configured to process a calculation operation related to machine learning.

The memory 1902 may include one or more computer-readable storage media that may be non-transitory. The memory 1902 may further include a high-speed random access memory and a non-transitory memory, for example, one or more magnetic disk storage devices or flash storage devices. In some embodiments, the non-transitory computer-readable storage medium in the memory 1902 is configured to store at least one instruction, and the at least one instruction being configured to be executed by the processor 1901 to implement the resource transfer method based on a blockchain system provided in the method embodiments of the present disclosure.

A person skilled in the art may understand that the structure shown in FIG. 19 does not constitute a limitation to the terminal 1900, and the terminal may include more or fewer components than those shown in the figure, or some components may be combined, or a different component arrangement may be used.

FIG. 20 is a schematic structural diagram of a computing device according to an embodiment of the present disclosure. The computing device 2000 may vary a lot due to different configurations or performance, and may include one or more processors (CPUs) 2001 and one or more memories 2002. The memory 2002 stores at least one instruction, the at least one instruction being loaded and executed by the processor 2001 to implement the methods provided in the method embodiments. In certain embodiment(s), the computing device may also have components such as a wired or wireless network interface, a keyboard, and an input/output interface for ease of input/output, and may further include other components for implementing functions of the device, which will not be described in detail herein.

The term unit (and other similar terms such as subunit, module, submodule, etc.) in this disclosure may refer to a software unit, a hardware unit, or a combination thereof. A software unit (e.g., computer program) may be developed using a computer programming language. A hardware unit may be implemented using processing circuitry and/or memory. Each unit can be implemented using one or more processors (or processors and memory). Likewise, a processor (or processors and memory) can be used to implement one or more units. Moreover, each unit can be part of an overall unit that includes the functionalities of the unit.

The embodiments of the present disclosure further provide a computer-readable storage medium. The computer-readable storage medium is applicable to a node device. The computer-readable storage medium stores at least one segment of program code. The at least one segment of program code is configured to be executed by a processor to implement the operations executed by the node device in the resource transfer method based on a blockchain system in the embodiments of the present disclosure.

The embodiments of the present disclosure further provide a computer program product or a computer program. The computer program product or the computer program includes computer instructions, the computer instructions being stored in a computer-readable storage medium. A processor of a computing device reads the computer instructions from the computer-readable storage medium, and executes the computer instructions, so that the computing device performs the blockchain-based resource transfer method provided in certain embodiment(s).

Those of ordinary skill in the art may understand that all or part of the steps of implementing the embodiments may be implemented by hardware, or may be implemented by a program instructing related hardware. The program may be stored in a computer-readable storage medium. The storage medium may be a read-only memory, a magnetic disk, or an optical disc.

The descriptions are directed to certain embodiment(s) of the present disclosure, but are not intended to limit the present disclosure. Any modification, equivalent replacement, or improvement made within the spirit and principle of the present disclosure shall fall within the protection scope of the present disclosure.

What is claimed is:

1. A resource transfer method based on a blockchain system, applied to a node device in the blockchain system, the method comprising:
receiving a first service request, the first service request including a first account and a first service, and the first service being corresponding to a first quantity of virtual resources;
transferring the first quantity of the virtual resources from the first account to a second account of the node device in response to the virtual resources stored in the first account being not less than the first quantity, and providing the first service to the first account;
broadcasting a first target block to the blockchain system, the first target block including a resource transfer record and a service provision record corresponding to the first service request; and
adding the first target block to a blockchain of the node device in response to the first target block passing a consensus check,
the virtual resource including at least one of an institutional virtual resource or a universal virtual resource, the institutional virtual resource being generated by the node device, the universal virtual resource being generated by a central node device in the blockchain system, and the institutional virtual resource and the universal virtual resource being correspondingly transferred according to a transfer ratio.

2. The method according to claim 1, wherein transferring the first quantity of the virtual resources comprises:
determining virtual resources according to a transfer sequence of the first account and the quantity of the virtual resources stored in the first account, wherein the virtual resource includes at least one of the institutional virtual resource or the universal virtual resource; and
transferring a second quantity of the virtual resources from the first account to the second account of the node device, wherein the second quantity is a quantity of the virtual resources corresponding to the first service.

3. The method according to claim 2, further comprising:
receiving a first transfer sequence setting request, wherein the first transfer sequence setting request includes the first account and a first transfer sequence, the first transfer sequence includes use of the institutional virtual resources for transfer, or, the first transfer sequence includes use of the universal virtual resources for transfer; and setting the transfer sequence of the first account to the first transfer sequence; or
setting, during creation of the first account, the transfer sequence of the first account to using a default resource type for transfer, wherein the default resource type is the institutional virtual resource or the universal virtual resource.

4. The method according to claim 2, wherein determining the virtual resources comprises:
acquiring a quantity of the institutional virtual resources stored in the first account in response to the transfer sequence of the first account using the institutional virtual resources for transfer; and
determining the institutional virtual resources as the virtual resources in response to the quantity of the institutional virtual resources stored in the first account being not less than a quantity of the institutional virtual resources corresponding to the first service.

5. The method according to claim 4, further comprising:
acquiring a quantity of the universal virtual resources corresponding to the first service in response to the quantity of the institutional virtual resources stored in the first account being less than the quantity of the institutional virtual resources corresponding to the first service;
determining the universal virtual resources as the virtual resources in response to the quantity of the universal virtual resources stored in the first account being not less than the quantity of the universal virtual resources corresponding to the first service, wherein the universal virtual resources stored in the first account are obtained by transferring currency resources from the first account to the central node device; and
storing a transfer record of the universal virtual resources corresponding to the first service in a memory pool of the node device.

6. The method according to claim 1, further comprising:
acquiring an institutional virtual resource difference between a quantity of the institutional virtual resources corresponding to the first service and a quantity of the institutional virtual resources stored in the first account in response to the quantity of the virtual resources stored in the first account being less than the first quantity;
returning first prompt information including the institutional virtual resource difference to the first account;
in response to receiving a user transfer request transmitted by the first account, transferring a first transfer quantity of the institutional virtual resources indicated in the user transfer request from the second account to the first account, and receiving the universal virtual resources or currency resources that correspond to the first transfer quantity of the institutional virtual resources and that are transferred from the first account to the second account, wherein the first transfer quantity is not less than the institutional virtual resource difference;
transferring a quantity of the institutional virtual resources corresponding to the first service from the first account to the second account of the node device; and
storing the user transfer request, a transfer record of the first transfer quantity of the institutional virtual resources, and a transfer record of the universal virtual resources or the currency resources that correspond to the first transfer quantity of the institutional virtual resources in a memory pool of the node device.

7. The method according to claim 6, further comprising:
transmitting a generation request to the central node device, wherein the generation request includes a second transfer quantity of the institutional virtual resources to be generated and an additional issuance multiple;
transferring a third transfer quantity of the universal virtual resources to a third account of the central node device according to a generation response including a first transfer ratio that is returned by the central node device, and generating the second transfer quantity of the institutional virtual resources, wherein the first transfer ratio is used for indicating an exchange ratio of the universal virtual resource to the institutional virtual resource, and the second transfer quantity is equal to a product of the third transfer quantity, the first transfer ratio, and the additional issuance multiple; and
storing the generation request, the generation response, a transfer record of the third transfer quantity of the universal virtual resources, and a generation record of the second transfer quantity of the institutional virtual resources in the memory pool of the node device.

8. The method according to claim 6, further comprising:
transmitting a first transfer request to the central node device in the blockchain system, wherein the first transfer request includes a fourth transfer quantity of the institutional virtual resources to be transferred;
destructing the fourth transfer quantity of the institutional virtual resources from the second account according to a first transfer response including a second transfer ratio that is returned by the central node device, and receiving a fifth transfer quantity of the universal virtual resources transferred from a third account of the central node device to the second account, wherein the second transfer ratio is generated by the central node device according to a current risk level of the node device, the second transfer ratio is used for indicating an exchange ratio of the institutional virtual resources to the universal virtual resources, and the fifth transfer quantity is equal to a product of the fourth transfer quantity and the second transfer ratio; and
storing the first transfer request, the first transfer response, a destruction record of the fourth transfer quantity of the institutional virtual resources, and a receipt record of the fifth transfer quantity of the universal virtual resources in the memory pool of the node device.

9. The method according to claim 6, further comprising:
transmitting a second transfer request to the central node device in the blockchain system, wherein the second transfer request includes a sixth transfer quantity of the universal virtual resources to be transferred;
transferring the sixth transfer quantity of the universal virtual resources from the second account to a third account of the central node device according to a second transfer response including a third transfer ratio that is returned by the central node, and receiving a seventh transfer quantity of currency resources transferred by the central node device from the third account to the second account, wherein the third transfer ratio is used for indicating an exchange ratio of the universal virtual resources to the currency resources, and the seventh transfer quantity is equal to a product of the sixth transfer quantity and the third transfer ratio; and
storing the second transfer request, the second transfer response, a transfer record of the sixth transfer quantity of the universal virtual resources, and a receipt record of the seventh transfer quantity of the currency resources in the memory pool of the node device.

10. The method according to claim 1, further comprising:
packaging resource transfer information stored in a memory pool of the node device to generate the first target block, wherein the resource transfer information includes the resource transfer record and the service provision record corresponding to the first service request.

11. A resource transfer apparatus based on a blockchain system, the apparatus comprising: a memory storing computer program instructions; and a processor coupled to the memory and configured to execute the computer program instructions and perform:
receiving a first service request, the first service request including a first account and a first service, and the first service being corresponding to a first quantity of virtual resources;
transferring the first quantity of the virtual resources from the first account to a second account of the node device in response to a quantity of the virtual resources stored in the first account being not less than the first quantity, and provide the first service to the first account;
broadcasting a first target block to the blockchain system, the first target block including a resource transfer record and a service provision record corresponding to the first service request; and
adding the first target block to a blockchain of the node device in response to the first target block passing a consensus check,
the virtual resource including at least one of an institutional virtual resource or a universal virtual resource, the institutional virtual resource being generated by a node device, the universal virtual resource being generated by a central node device in the blockchain system, and the institutional virtual resource and the universal virtual resource being correspondingly transferred according to a transfer ratio.

12. The resource transfer apparatus according to claim 11, wherein transferring the first quantity of the virtual resources includes:
determining virtual resources according to a transfer sequence of the first account and the quantity of the virtual resources stored in the first account, wherein the virtual resource includes at least one of the institutional virtual resource or the universal virtual resource; and
transferring a second quantity of the virtual resources from the first account to the second account of the node device, wherein the second quantity is a quantity of the virtual resources corresponding to the first service.

13. The resource transfer apparatus according to claim 12, wherein the processor is further configured to execute the computer program instructions and perform:
receiving a first transfer sequence setting request, wherein the first transfer sequence setting request includes the first account and a first transfer sequence, the first transfer sequence includes use of the institutional virtual resources for transfer, or, the first transfer sequence includes use of the universal virtual resources for transfer; and setting the transfer sequence of the first account to the first transfer sequence; or
setting, during creation of the first account, the transfer sequence of the first account to using a default resource type for transfer, wherein the default resource type is the institutional virtual resource or the universal virtual resource.

14. The resource transfer apparatus according to claim 12, wherein determining the virtual resources includes:
acquiring a quantity of the institutional virtual resources stored in the first account in response to the transfer sequence of the first account using the institutional virtual resources for transfer; and
determining the institutional virtual resources as the virtual resources in response to the quantity of the institutional virtual resources stored in the first account being not less than a quantity of the institutional virtual resources corresponding to the first service.

15. The resource transfer apparatus according to claim 14, wherein the processor is further configured to execute the computer program instructions and perform:
acquiring a quantity of the universal virtual resources corresponding to the first service in response to the quantity of the institutional virtual resources stored in the first account being less than the quantity of the institutional virtual resources corresponding to the first service;
determining the universal virtual resources as the virtual resources in response to the quantity of the universal virtual resources stored in the first account being not less than the quantity of the universal virtual resources corresponding to the first service, wherein the universal virtual resources stored in the first account are obtained by transferring currency resources from the first account to the central node device; and
storing a transfer record of the universal virtual resources corresponding to the first service in a memory pool of the node device.

16. The resource transfer apparatus according to claim 11, wherein the processor is further configured to execute the computer program instructions and perform:
acquiring an institutional virtual resource difference between a quantity of the institutional virtual resources corresponding to the first service and a quantity of the institutional virtual resources stored in the first account in response to the quantity of the virtual resources stored in the first account being less than the first quantity;
returning first prompt information including the institutional virtual resource difference to the first account;
in response to receiving a user transfer request transmitted by the first account, transferring a first transfer quantity of the institutional virtual resources indicated in the user transfer request from the second account to the first account, and receiving the universal virtual resources or currency resources that correspond to the first transfer quantity of the institutional virtual resources and that are transferred from the first account to the second account, wherein the first transfer quantity is not less than the institutional virtual resource difference;
transferring a quantity of the institutional virtual resources corresponding to the first service from the first account to the second account of the node device; and
storing the user transfer request, a transfer record of the first transfer quantity of the institutional virtual resources, and a transfer record of the universal virtual resources or the currency resources that correspond to the first transfer quantity of the institutional virtual resources in a memory pool of the node device.

17. The resource transfer apparatus according to claim 16, wherein the processor is further configured to execute the computer program instructions and perform:
transmitting a generation request to the central node device, wherein the generation request includes a second transfer quantity of the institutional virtual resources to be generated and an additional issuance multiple;
transferring a third transfer quantity of the universal virtual resources to a third account of the central node device according to a generation response including a first transfer ratio that is returned by the central node device, and generating the second transfer quantity of the institutional virtual resources, wherein the first transfer ratio is used for indicating an exchange ratio of the universal virtual resource to the institutional virtual resource, and the second transfer quantity is equal to a product of the third transfer quantity, the first transfer ratio, and the additional issuance multiple; and
storing the generation request, the generation response, a transfer record of the third transfer quantity of the universal virtual resources, and a generation record of the second transfer quantity of the institutional virtual resources in the memory pool of the node device.

18. The resource transfer apparatus according to claim 16, wherein the processor is further configured to execute the computer program instructions and perform:
transmitting a first transfer request to the central node device in the blockchain system, wherein the first transfer request includes a fourth transfer quantity of the institutional virtual resources to be transferred;
destructing the fourth transfer quantity of the institutional virtual resources from the second account according to a first transfer response including a second transfer ratio that is returned by the central node device, and receiving a fifth transfer quantity of the universal virtual resources transferred from a third account of the central node device to the second account, wherein the second transfer ratio is generated by the central node device according to a current risk level of the node device, the second transfer ratio is used for indicating an exchange ratio of the institutional virtual resources to the universal virtual resources, and the fifth transfer quantity is equal to a product of the fourth transfer quantity and the second transfer ratio; and
storing the first transfer request, the first transfer response, a destruction record of the fourth transfer quantity of the institutional virtual resources, and a receipt record of the fifth transfer quantity of the universal virtual resources in the memory pool of the node device.

19. The resource transfer apparatus according to claim 16, wherein the processor is further configured to execute the computer program instructions and perform:
transmitting a second transfer request to the central node device in the blockchain system, wherein the second transfer request includes a sixth transfer quantity of the universal virtual resources to be transferred;
transferring the sixth transfer quantity of the universal virtual resources from the second account to a third account of the central node device according to a second transfer response including a third transfer ratio that is returned by the central node, and receiving a seventh transfer quantity of currency resources transferred by the central node device from the third account to the second account, wherein the third transfer ratio is used for indicating an exchange ratio of the universal virtual resources to the currency resources, and the seventh transfer quantity is equal to a product of the sixth transfer quantity and the third transfer ratio; and
storing the second transfer request, the second transfer response, a transfer record of the sixth transfer quantity of the universal virtual resources, and a receipt record of the seventh transfer quantity of the currency resources in the memory pool of the node device.

20. A non-transitory computer-readable storage medium storing computer program instructions executable by at least one processor to perform:
receiving a first service request, the first service request including a first account and a first service, and the first service being corresponding to a first quantity of virtual resources;
transferring the first quantity of the virtual resources from the first account to a second account of the node device in response to the virtual resources stored in the first account being not less than the first quantity, and providing the first service to the first account;
broadcasting a first target block to the blockchain system, the first target block including a resource transfer record and a service provision record corresponding to the first service request; and
adding the first target block to a blockchain of the node device in response to the first target block passing a consensus check,
the virtual resource including at least one of an institutional virtual resource or a universal virtual resource, the institutional virtual resource being generated by a node device, the universal virtual resource being generated by a central node device in a blockchain system, and the institutional virtual resource and the universal virtual resource being correspondingly transferred according to a transfer ratio.
